(19) United States
(12) Patent Application Publication
(10) Pub. No.: US 2011/0091119 A1
(43) Pub. Date: Apr. 21, 2011

(54) Coding apparatus and coding method

(75) Inventors: Takahiro Fukuhara, Kanagawa (JP); Katsutoshi Ando, Kanagawa (JP); Koji Hara, Kanagawa (JP)

(73) Assignee: Sony Corporation, Tokyo (JP)

(21) Appl. No.: 12/924,905

(22) Filed: Oct. 7, 2010

(30) Foreign Application Priority Data
Oct. 21, 2009 (JP) P2009-242770

(51) Int. Cl. G06K 9/46

(52) U.S. Cl. 382/232

(57) ABSTRACT

A coding apparatus includes: a bit modeling section which performs bit modeling for coding for coefficient data of every sub-band obtained by wavelet-transforming image data; an expanding section which expands a plurality of data sets including a symbol, a context and control information obtained by the bit modeling section in a register as input data; a storing section which stores the input data expanded by the expanding section as buffer data; a integrating section which integrates the data set in which the control information is valid in the input data expanded by the expanding section and the data set in which the control information is valid in the buffer data stored in the storing section; and a coding section which codes the data sets in which the control information is valid, which are integrated by the integrating section.

### BACKGROUND OF THE INVENTION

1. Field of the Invention

The present invention relates to a coding apparatus and a coding method, and more particularly, to a coding apparatus and a coding method which can perform coding at a high speed.

2. Description of the Related Art

JPEG (Joint Photographic Experts Group) 2000 standardized by ISO/IEC (International Organization for Standardization/International Electrotechnical Commission) in 2000 is an image coding system having a variety of functions of a high compression ratio, lossless and lossy compression, scalability (resolution, image quality and the like), error tolerance and so on, which is highly expected to be an alternative technique of JPEG.

In 2004, JPEG2000 Part-1 was selected as a standard codec according to DCI (Digital Cinema Initiative). Accordingly, image photographing, image editing and image delivery of digital cinema can be all integrated under JPEG2000.

Further, medical images, satellite photograph images or the like should be necessarily stored in an original state. Recently, a variety of digital single lens reflex cameras can store raw data or RGB data acquired by an image sensor such as CCD (Charge Coupled Device) or CMOS (Complementary Metal Oxide Semiconductor) in a non-compressed state in a memory card.

However, the non-compression of master images is advantageous in that loss of image data can be prevented, but is disadvantageous in that the data size becomes large. For this reason, the expectation of compression and decompression according to the JPEG2000 lossless compression is growing these days, for example, even in the use where image quality is considered important, as described above, in addition to digital cinema.

Japanese Patent No. 3,906,630 discloses an image coding apparatus which includes both a fixed-point type wavelet transformer and an integer type wavelet transformer, which can perform both a lossless transform and a lossy transform and can increase the degree of freedom of selection of image quality and compression ratio.

### SUMMARY OF THE INVENTION

However, JPEG2000 may be problematic in that its calculation load is remarkably larger than JPEG, and particularly, in that overall coefficient data is compressed without loss in the case of lossless compression, which causes too much time.

In such a JPEG2000 coding technique, an entropy coding section referred to as EBCOT (Embedded Block Coding with Optimized Truncation) occupies the largest calculation load. This EBCOT employs a technique which arithmetically codes binary data being expanded in bit-planes while modeling the binary data in the unit of one pixel. Thus, after sequential processing is performed, “dependence” occurs in which a result of an upper bit-plane affects a result of a lower bit-plane, thereby making it difficult to parallelize the inside of code blocks. Therefore, in the case of encoding and lossless compression for an image having a high level of resolution, how to realize high-speed processing of the calculation load of JPEG2000, in particular EBCOT, has been a key issue.

The inside structure of EBCOT is divided into a bit modeling section and an MQ coding section. In the bit modeling, wavelet transform coefficients or quantization coefficients are expanded in bit-planes, and coding is performed in three encoding units referred to as coding passes, in the unit of rectangular code blocks. In each coding pass, a predetermined parameter group is output to the MQ coding section as necessary. The MQ coding section generates a code word using the parameter group.

For high-speed processing of EBCOT, it is necessary to reduce the calculation load in the bit modeling section and the MQ coding section.

Accordingly, it is desirable to provide a coding apparatus and a coding method which is capable of performing coding at a high speed.

According to an embodiment of the present invention, there is provided a coding apparatus including: bit modeling means for performing bit modeling for coding for coefficient data of every sub-band obtained by wavelet-transforming image data; expanding means for expanding a plurality of data sets including a symbol, a context and control information obtained by the bit modeling means in a register as input data; storing means for storing the input data expanded by the expanding means as buffer data; integrating means for integrating the data set in which the control information is valid in the input data expanded by the expanding means and the data set in which the control information is valid in the buffer data stored in the storing means; and coding means for coding the data sets in which the control information is valid, which are integrated by the integrating means.

The integrating means may integrate the data sets in which the control information is valid by detecting the data set in which the control information is invalid in the buffer data and by moving the data set, which is located in the same position as the detected data set in the buffer data, among the data set in which the control information is valid in the input data to the same position of the buffer data.

The coding apparatus may further include reading means for reading the buffer data from the storing means in a case where the data set in which the control information is valid is included in the input data, after the data sets are integrated by the integrating means, wherein the coding section may code the data set in which the control information is valid in the buffer data read by the reading means, and wherein the storing means may store the input data expanded in the register as new buffer data, after the buffer data is read by the reading means.

The coding apparatus may further include aligning means for rearranging the buffer data read from the storing means by the reading means to collect the data set in which the control information is valid, wherein the coding means may code the data set in which the control information is valid, which is rearranged and collected by the aligning means.

The coding means may code the different data sets in which the control information is valid, which are integrated by the integrating means, a plurality of times in parallel.

The expanding means may expand the data set corresponding to each sample, located in the same position, of a plurality of code blocks in the register as the input data.

The coding apparatus may further include grouping means for grouping the plurality of code blocks by a predetermined number of code blocks having the same characteristic, wherein the expanding means may expand, for every group generated by the grouping means, the data set corresponding to the sample, located in the same position, of each code block in the group, in the register as the input data.

The grouping means may group the code blocks on the basis of parameters representing the characteristic of the code blocks, including the horizontal size and vertical size of the code blocks, the number of coding passes used in the code blocks and the sub-band type to which the code blocks belong.

The bit modeling means may select one of a CU pass, an SP pass and an MR pass by which the coding is to be performed and may perform a predetermined operation by the selected coding pass.

The control information may be transmitted from the CU pass, and may be any one of valid and invalid information in which a result of run-length coding is 0, valid and invalid information in which the run-length coding result is 1, valid and invalid information on whether or not to perform the CU coding, and valid and invalid information on whether or not to perform sign coding.

The control information may be transmitted from the SP pass, and may be any one of valid and invalid information on whether or not to perform SP coding, and valid and invalid information on whether or not to perform sign coding.

The control information may be transmitted from the MR pass, and may be valid and invalid information on whether or not to perform MR coding.

According to an embodiment of the present invention, there is provided a coding method including the steps of: performing bit modeling for coding for coefficient data of every sub-band obtained by wavelet-transforming image data; expanding a plurality of data sets including a symbol, a context and control information obtained by the bit modeling in a register as input data; storing the input data expanded in the register in a storing section as buffer data; integrating the data set in which the control information is valid in the input data expanded in the register and the data set in which the control information is valid in the buffer data stored in the storing section; and coding the integrated data sets in which the control information is valid.

According to an embodiment of the present invention, bit modeling for coding is performed for coefficient data of every sub-band obtained by wavelet-transforming image data; a plurality of data sets including a symbol, a context and control information obtained by the bit modeling is expanded in a register as input data; the input data expanded in the register is stored in a storing section as buffer data; the data set in which the control information is valid in the input data expanded in the register and the data set in which the control information is valid in the buffer data stored in the storing section are integrated with each other; and the integrated data sets in which the control information is valid are coded.

According to the embodiments, it is possible to code the image, in particular, to code the image at a high speed.

### BRIEF DESCRIPTION OF THE DRAWINGS

FIG. 1 is a block diagram illustrating an example of a main configuration of an image coding apparatus according to embodiment of the present invention.

FIG. 2 is a diagram illustrating an example of a configuration of sub-bands.

FIG. 3 is a diagram illustrating an example of bit-planes.

FIG. 4 is a diagram illustrating an example of code blocks in respective sub-bands.

FIG. 5 is a diagram illustrating an example of coding passes.

FIG. 6 is a diagram illustrating an example of scanning of coefficients.

FIG. 7 is a diagram illustrating coding passes.

FIG. 8 is a block diagram illustrating an example of a detailed configuration of EBCOT in FIG. 1.

FIG. 9 is a diagram illustrating the relation between bit modeling and MQ coding.

FIG. 10 is a flowchart illustrating an example of a flow of a coding process.

FIG. 11 is a flowchart illustrating an example of a flow of a bit modeling process.

FIG. 12 is a flowchart illustrating an example of a flow of a CU pass process.

FIG. 13 is a flowchart illustrating an example of the CU pass process, which follows on from FIG. 12.

FIG. 14 is a flowchart illustrating an example of a process in which an actual operation of a CU pass process is generated.

FIG. 15 is a flowchart illustrating another example of a process in which an actual operation of a CU pass process is generated.

FIG. 16 is a flowchart illustrating still another example of a process in which an actual operation of a CU pass process is generated.

FIG. 17 is a flowchart illustrating an example of a flow of an SP pass process.

FIG. 18 is a flowchart illustrating an example of a flow of an MR pass process.

FIG. 19 is a flowchart illustrating an example of a flow of an MQ coding process.

FIG. 20 is a diagram illustrating an expansion of a data group in a register.

FIG. 21 is a diagram illustrating an expansion of a data group in a register.

FIG. 22 is a diagram illustrating an example of a configuration of a data group expanded in a register.

FIG. 23 is a diagram illustrating an example of an integrated state.

FIG. 24 is a diagram illustrating an example of an integrated state.

FIG. 25 is a diagram illustrating rearrangement of a data group.

FIG. 26 is a block diagram illustrating another example of a configuration of an image coding apparatus according to an embodiment of the present invention.

FIGS. 27A, 27B and 27C are diagrams illustrating an example of grouped code blocks.

FIG. 28 is a diagram illustrating an example of a parallel process of MQ coding.

FIG. 29 is a flowchart illustrating another example of a flow of an MQ coding process.

FIG. 30 is a flowchart illustrating another example of a flow of an MQ coding process, which follows on from FIG. 29.

FIG. 31 is a diagram illustrating an example of hardware according to an embodiment of the present invention.

FIG. 32 is a diagram illustrating an example of a configuration of a personal computer according to an embodiment of the present invention.

### DESCRIPTION OF THE PREFERRED EMBODIMENTS

Hereinafter, preferred embodiments for carrying out the present invention will be described in the following order.

1. First embodiment (image coding apparatus)

2. Second embodiment (image coding apparatus)

3. Third embodiment (personal computer)

### 1. First Embodiment

### Configuration of Image Coding Apparatus

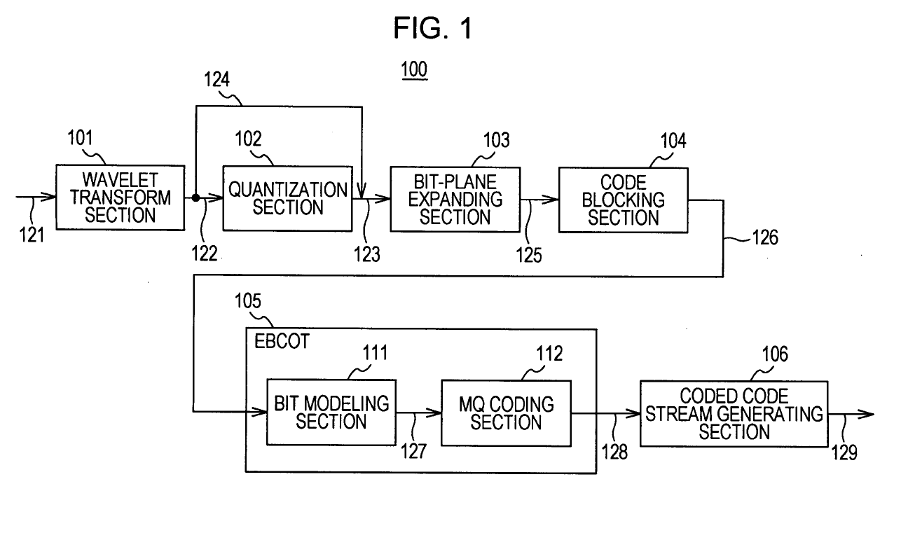

FIG. 1 is a diagram illustrating a configuration of an image coding apparatus according to of an embodiment of the present invention. An image coding apparatus 100 in FIG. 1 reversibly or irreversibly codes image data according to the JPEG (Joint Photographic Experts Group) 2000 system.

The image coding apparatus 100 wavelet-transforms the image data, expands obtained coefficients into a bit-plane for each code block, and performs entropy coding for each bit-plane.

The image coding apparatus 100 performs entropy coding called EBCOT (Embedded Block Coding with Optimized Truncation) specifically determined in the JPEG2000 standard (reference document: ISO/IEC 15444-1, Information technology-JPEG2000, Part 1: Core coding system).

The entropy coding called EBCOT (Embedded Block Coding with Optimized Truncation) is a technique which arithmetically codes binary data being expanded in bit-planes while modeling the binary data in the unit of one pixel.

In the related art, in this process, since “dependence” occurs in which a result of an upper bit-plane affects a result of a lower bit-plane after sequential processing is performed, it is difficult to parallelize the inside of code blocks. Therefore, in the case of encoding and lossless compression for an image having a high level of resolution, how to realize high-speed processing of the calculation load of JPEG2000, in particular EBCOT, has been a key issue.

Thus, the image coding apparatus 100 performs MQ coding (arithmetic coding) regardless of the bit modeling result in EBCOT, to thereby realize deletion of conditional branches in coding passes. Further, the image coding apparatus 100 integrates symbols or contexts having valid control information, to thereby perform the MQ coding for only valid data with high efficiency. Accordingly, the image coding apparatus 100 can realize high-speed processing of EBCOT, that is, reduction in the calculation load of JPEG2000.

As shown in FIG. 1, the image coding apparatus 100 includes a wavelet transform section 101, a quantization section 102, a bit-plane expanding section 103, a code blocking section 104, an EBCOT 105 and a coded code stream generating section 106.

The wavelet transform section 101 is typically realized by a filter bank including a low-pass filter and a high-pass filter. Further, since a digital filter generally has an impulse response (filter coefficient) having a length of a plurality of taps, the wavelet transform section 101 has a buffer for buffering in advance such an amount of an input image that is only to be filtered.

The wavelet transform section 101 obtains input image data (arrow 121) by a minimum data amount necessary for filtering or more. The wavelet transform section 101 filters the image data, for example, using a 5×3 wavelet transform filter to generate wavelet coefficients. The wavelet transform section 101 performs filtering so that the image data is separated into a low-frequency component and a high-frequency component in the respective vertical and horizontal directions of the image.

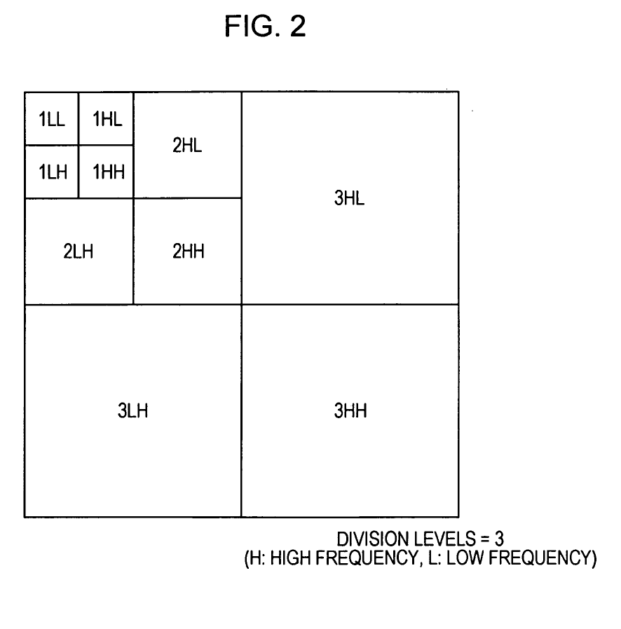

Further, the wavelet transform section 101 recursively repeats such a filtering process for sub-bands separated as the low-frequency component in both the vertical direction and the horizontal direction a predetermined number of times, as shown in FIG. 2. This considers the fact that most of image energy concentrates on the low-frequency component.

FIG. 2 is a diagram illustrating an example of a configuration of sub-bands generated by a wavelet transform process with three division levels. In this case, firstly, the wavelet transform section 101 filters the entire image to generate sub-bands 3LL (not shown), 3HL, 3LH, and 3HH. Next, the wavelet transform section 101 filters the generated sub-band 3LL to generate sub-bands 2LL (not shown), 2HL, 2LH, and 2HH. Then, the wavelet transform section 101 filters the generated sub-band 2LL to generate sub-bands 1LL, 1HL, 1LH, and 1HH.

The number of the division levels of the wavelet transform is arbitrary.

Returning to FIG. 1, the wavelet transform section 101 supplies the coefficient data (wavelet coefficients) obtained by the filtering for each sub-band to the quantization section 102 (arrow 122).

The quantization section 102 quantizes the supplied coefficient data (wavelet coefficients). The quantization section 102 supplies the obtained coefficient data (quantized coefficients) to the bit-plane expanding section 103 (arrow 123). In the JPEG2000 standard, the quantization process is omitted in the case of lossless compression. In this case, the coefficient data (wavelet coefficients) output from the wavelet transform section 101 is supplied to the bit-plane expanding section 103 (arrow 124).

The bit-plane expanding section 103 expands the supplied coefficient data into a bit-plane in each bit position.

The bit-plane is obtained by dividing (slicing) a coefficient group (for example, code blocks to be described later) of a predetermined number of wavelet coefficients for each bit, that is, in each position. That is, the bit-plane is a set of bits (coefficient bits), in the same position, of a plurality of pieces of data each having a bit depth of a plurality of bits. Accordingly, the number of the expanded bit-planes depends on the bit depth of each coefficient.

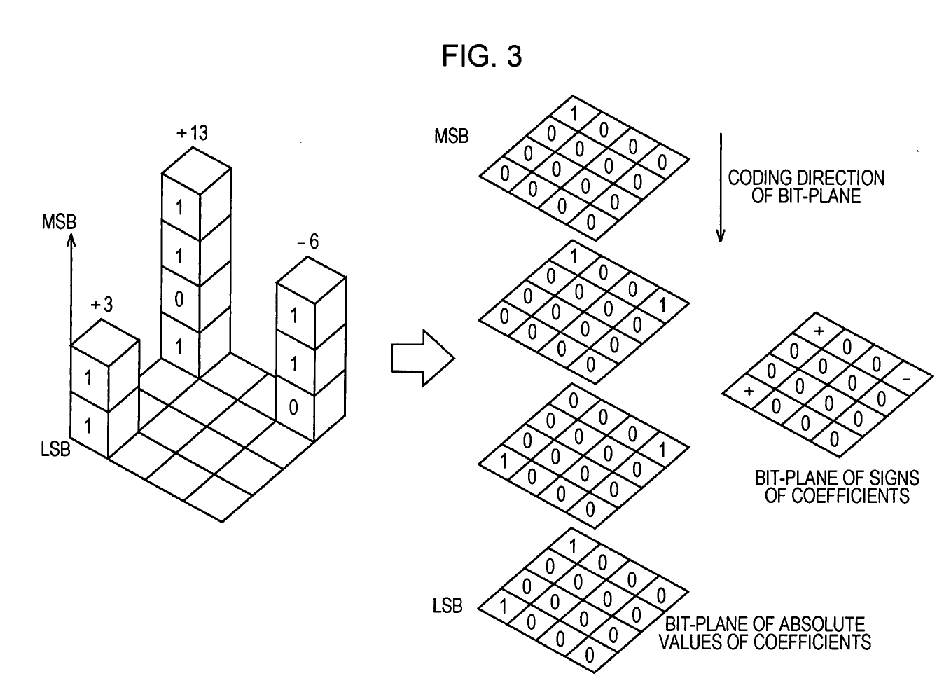

FIG. 3 shows a specific example of the bit-planes. A left diagram in FIG. 3 shows a total of 16 coefficients with four coefficients in the vertical direction and four coefficients in the horizontal direction. Among the 16 coefficients, a coefficient having a maximum absolute value is 13, which is represented as 1101 in a binary notation. The bit-plane expanding section 103 expands such a coefficient group into four bit-planes showing absolute values (bit-planes of absolute values) and one bit-plane showing signs (a bit-plane of signs). That is, the coefficient group on the left side in FIG. 3 is expanded into the four absolute value bit-planes and the one sign bit-plane, as shown on the right side in FIG. 3. All elements of the absolute value bit-planes assume a value of 0 or 1. Further, elements of the bit-plane showing signs assume one of a value indicating that the value of the coefficient is a positive value, a value indicating that the value of the coefficient is 0, and a value indicating that the value of the coefficient is a negative value.

The number of the coefficients in the coefficient group thus converted into the bit-planes is arbitrary. Hereinafter, the description will be made supposing that the bit-plane expanding section 103 expands coefficients into bit-planes for each code block, so as to facilitate processing in each section by integrating processing units.

Returning to FIG. 1, the bit-plane expanding section 103 supplies the code blocking section 104 with the expanded bit-planes in order from a most significant bit (MSB) of the coefficients to a least significant bit (LSB) thereof. That is, the bit-plane expanding section 103 supplies the code blocking section 104 with the expanded bit-planes in order from a higher level side to a lower level side of the bit depth (arrow 125).

The code blocking section 104 divides the supplied coefficient data of each bit-plane into rectangular code blocks of a predetermined size, which are processing units of entropy coding. According to the definition of the JPEG2000 standard, the vertical and horizontal sizes of the code blocks are uniform in any sub-band. Here, on opposite ends of the image (sub-band) or upper and lower ends thereof or the like, the code blocks having the same size may not be obtained.

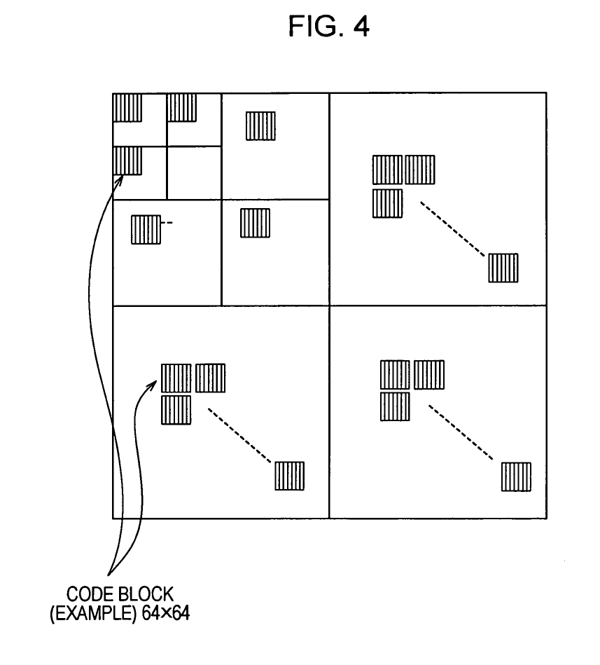

FIG. 4 illustrates the positional relation of code blocks in each sub-band as described with reference to FIG. 2. Code blocks of a size of about 64×64 pixels, for example, are generated in all the sub-bands after the division. For example, supposing that the sub-band 3HH at the lowest division level has a size of, for example, 640×320 pixels, the sub-band 3HH includes a total of 50 code blocks of 64×64 pixels. Each processing section in the following stages performs processing for each of the code blocks. Of course, the size (number of pixels) of the code blocks is arbitrary.

Returning to FIG. 1, the code blocking section 104 supplies the coefficient data expanded in the bit-planes to the EBCOT 105, for every code block (arrow 126).

The EBCOT 105 performs coding for each block of a predetermined size while measuring statistics of coefficients within the block. The EBCOT 105 performs entropy coding for the coefficient data (quantized coefficients) in the code block unit. Each code block is independently coded for each bit-plane from the most significant bit (MSB) to the least significant bit (LSB). The vertical and horizontal sizes of the code blocks are powers of 2 ranging from 4 to 256, and sizes generally used include 32×32, 64×64, 128×32 and the like. Suppose that a quantized coefficient value is represented by an n-bit binary number with a sign, and that bits of zero to n−1 represent respective bits from the LSB to the MSB. The remaining one bit indicates the sign. The code blocks are coded by the following three types of coding passes in order from the bit-plane on the MSB side.

(1) Significant Propagation Pass

(2) Magnitude Refinement Pass

(3) Cleanup Pass

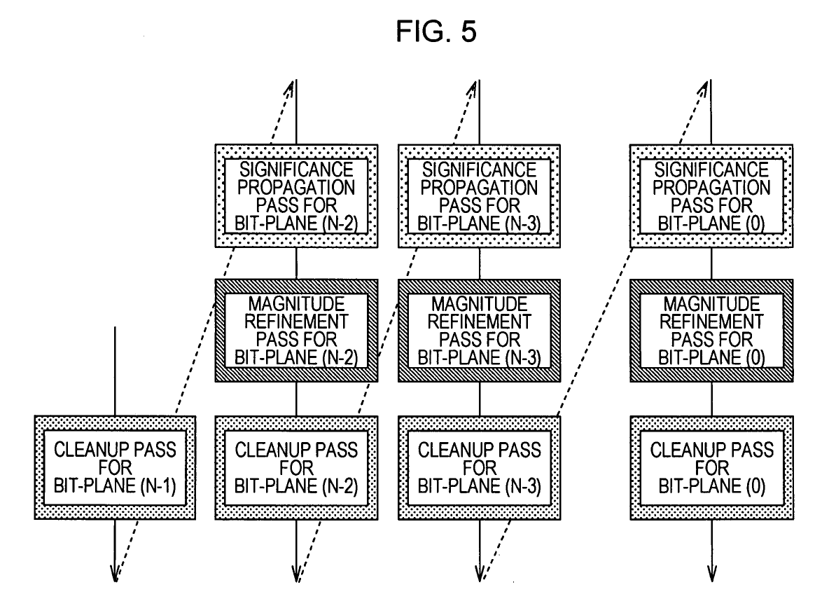

The order in which the three types of coding passes are used is shown in FIG. 5. Firstly, a bit-plane (n−1) (MSB) is coded by Cleanup Pass. Then, each bit-plane is sequentially coded toward the LSB side using the three coding passes in the order of Significant Propagation Pass, Magnitude Refinement Pass and Cleanup Pass.

However, in reality, the EBCOT 105 writes in what number bit-plane from the MSB side one first appears in a header, and does not code bit-planes whose coefficients are all zero and which continue from the MSB side (which will be referred to as zero bit-planes). The coding is performed repeatedly using the three types of coding passes in the above order, and is terminated in an arbitrary coding pass of an arbitrary bit-plane, to thereby acquire trade-off between code amount and image quality (performing a rate control).

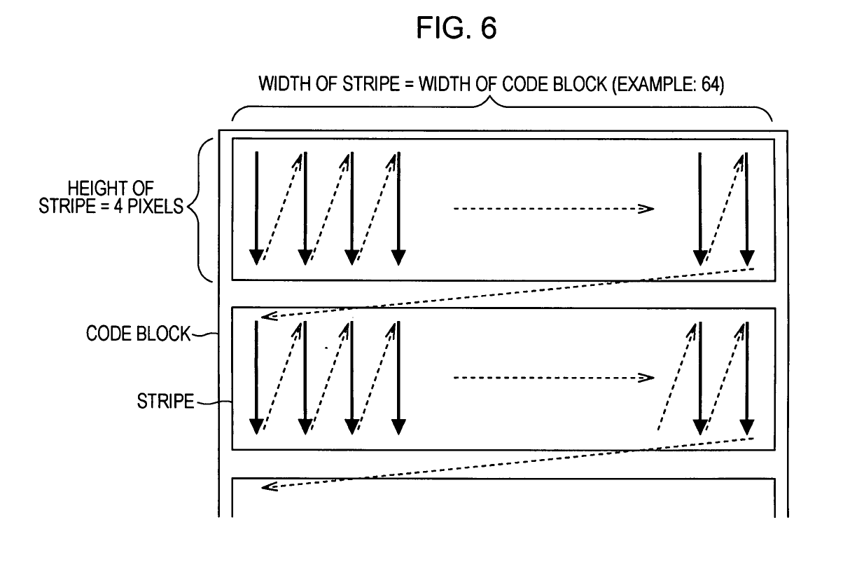

Next, the scanning of coefficients will be described with reference to FIG. 6. A code block is divided into stripes each having a height of four coefficients. The width of the stripe is equal to the width of the code block. A scan order is an order in which all coefficients within one code block are traced, and is an order from an upper stripe to a lower stripe in the code block, and order from a left column to a right column in a stripe, and an order from a top to a bottom in a column. All the coefficients in the code block are processed in this scan order in each coding pass.

Hereinafter, the three types of coding passes will be described, which are disclosed in JPEG-2000 standard (reference document: ISO/IEC 15444-1, Information technology-JPEG2000, Part 1: Core coding system).

### (1) Significance Propagation Pass (SP Pass)

In Significance Propagation Pass for coding a certain bit-plane, values in the bit-plane of such non-significant coefficients that at least one of 8-neighbor coefficients is significant are subjected to arithmetic coding. When the coded value of the bit-plane is one, information indicating whether a sign is positive or negative is subsequently subjected to the MQ coding.

The word “significance” which is a special term in JPEG2000 will be described. The significance refers to the state of an encoder for each coefficient, in which an initial value of the significance is zero indicating “non-significant”, the value is changed to one indicating “significant” when one is coded in the concerned coefficient, and then the value is continued as one. Accordingly, the significance can be also referred to as a flag indicating whether information on valid digits has already been coded. When a coefficient becomes significant in a certain bit-plane, the coefficient remains significant in subsequent bit-planes.

### (2) Magnitude Refinement Pass (MR Pass)

In Magnitude Refinement Pass for coding the bit-plane, values in the bit-plane of significant coefficients not coded in Significance Propagation Pass for coding the bit-plane are subjected to the MQ coding.

(3) Cleanup Pass (CU pass)

In Cleanup Pass for coding the bit-plane, values in the bit-plane of non-significant coefficients not coded in Significance Pass for coding the bit-plane are subject to the MQ coding. When the coded value of the bit-plane is one, information indicating whether a sign is positive or negative is subsequently subjected to the MQ coding.

In the MQ coding in the above three coding passes, methods such as ZC (Zero Coding), RLC (Run-Length Coding), SC (Sign Coding) and MR (Magnitude Refinement) are used properly on a case-by-case basis. Here, the arithmetic coding referred to as the MQ coding is used in this case. The MQ coding is a learning type binary arithmetic code defined in JBIG2 (reference document: ISO/IEC FDIS 14492, “Lossy/Lossless Coding of Bi-level Images”, March 2000).

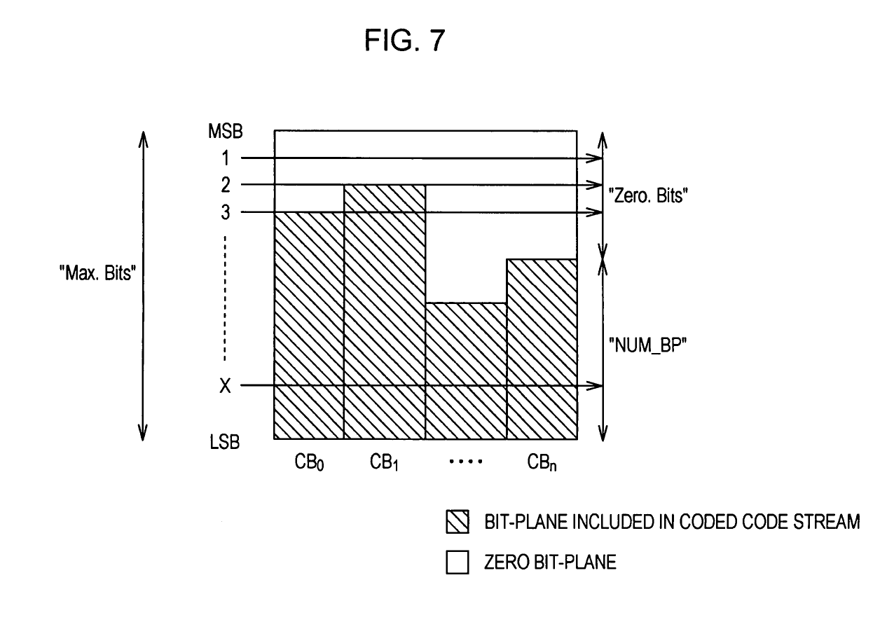

In FIG. 7, the horizontal axis represents code blocks (CB₀ to CBₙ: code blocks of (n+1) items) and the vertical axis represents bit-planes. Bit-planes whose coefficients are all zero and which continue from the bit-plane of the MSB are referred to as zero bit-planes, and other bit-planes are referred to as valid bit-planes. Further, in FIG. 7, “Zero.Bits” represents the number of the zero bit-planes, and “Max.Bits” represents the maximum bit depth (LSB or MSB) defined before encoding.

Accordingly, the number of coding passes (num_pass), which indicates the number of coding passes used in one code block, is calculated according to the following formula (1).

num_pass=(Max.Bits−Zero.Bits)×3−2 (1)

As shown in FIG. 1, the EBCOT 105 includes a bit modeling section 111 which performs bit modeling, and an MQ coding section 112 which performs arithmetic coding. The bit modeling section 111 performs bit modeling and then supplies information such as control information, symbols, contexts or the like to the MQ coding section 112 (arrow 127). The MQ coding section 112 performs the MQ coding using the supplied data group. The MQ coding section 112 supplies the coded code stream generating section 106 with the coded data generated by the MQ coding (arrow 128).

The coded code stream generating section 106 aligns the coded data supplied from the EBCOT 105 (MQ coding section 112), and outputs it as one code stream (arrow 129).

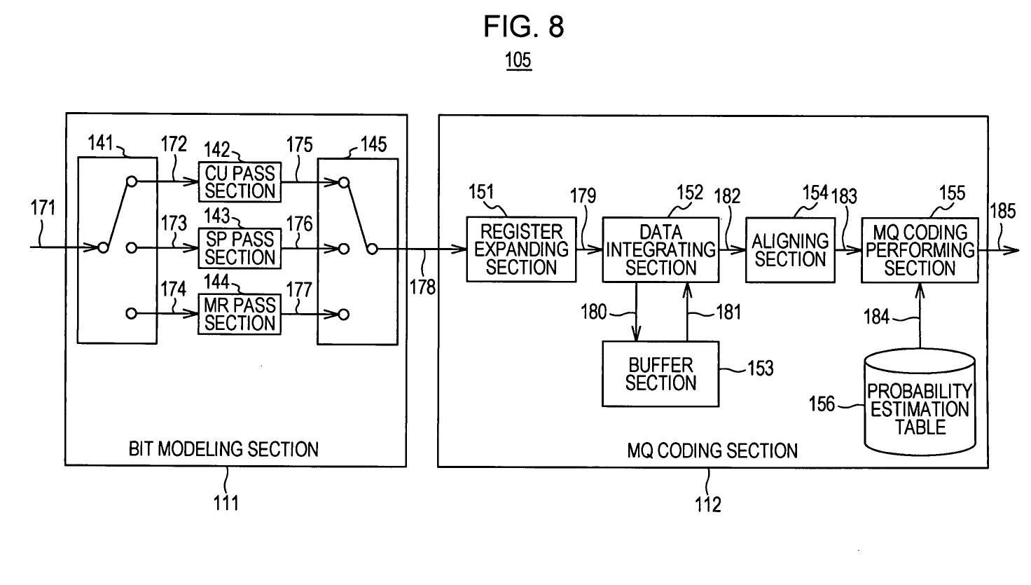

FIG. 8 is a block diagram illustrating an example of a detailed configuration of the EBCOT 105 in FIG. 1.

As shown in FIG. 8, the bit modeling section 111 of the EBCOT 105 includes a selecting section 141, a CU pass section 142, an SP pass section 143, an MR pass section 144 and a switching section 145.

The selecting section 141 selects one from the CU pass section 142, the SP pass section 143 and the MR pass section 144 as a supply target of the coefficient data (arrow 171) supplied from the code blocking section 104, and supplies the coefficient data to the selected supply target.

For example, in a case where the selecting section 141 selects the CU pass section 142, the selecting section 141 supplies the CU pass section 142 with the coefficient data (arrow 172). Further, for example, in a case where the selecting section 141 selects the SP pass section 143, the selecting section 141 supplies the SP pass section 143 with the coefficient data (arrow 173). In addition, for example, in a case where the selecting section 141 selects the MR pass section 144, the selecting section 141 supplies the MR pass section 144 with the coefficient data (arrow 174).

The CU pass section 142, the SP pass section 143 and the MR pass section 144 perform a predetermined calculation for the coefficient data by each coding pass for coding. The CU pass section 142, the SP pass section 143 and the MR pass section 144 supply the switching section 145 with a data group such as control information, symbols, contexts or the like, as an arithmetic result, respectively (arrows 175 to 177).

The switching section 145 properly switches the input coding passes, and supplies a register expanding section 151 of the MQ coding section 112 with the data group supplied from the CU pass section 142, the SP pass section 143 and the MR pass section 144 (arrow 178).

That is, a data set (of control information, symbols and contexts indicating valid or invalid) which will be described later is output from each coding pass, and is supplied to the register expanding section 151 as selection data.

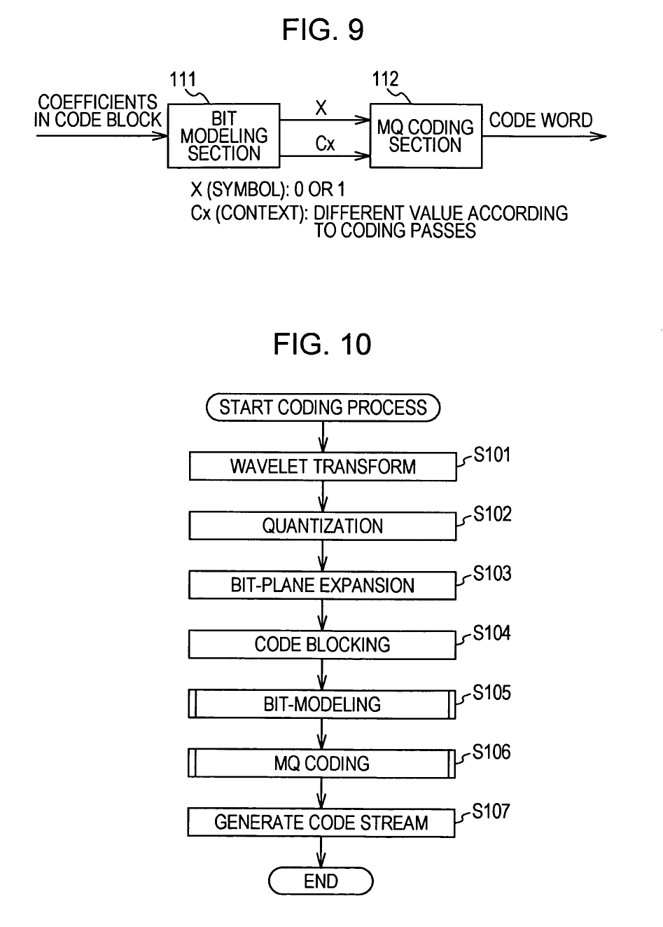

As shown in FIG. 9, in the case of typical JPEG2000, the MQ coding section 112 obtains a symbol X (0 or 1) transmitted from the bit modeling section 111 and a context (a value differently obtained according to the coding passes (0 to 18)) as a single pair, and performs the MQ coding on the basis of the pair.

Returning to FIG. 8, the MQ coding section 112 of the EBCOT 105 includes the register expanding section 151, a data integrating section 152, a buffer section 153, an aligning section 154, an MQ coding performing section 155 and a probability estimation table.

The register expanding section 151 supplies the data integrating section 152 with the supplied data set group (arrow 179), and expands it in the register. The data integrating section 152 integrates the data expanded in the register with the data stored in the buffer section 153 (arrows 180 and 181).

The buffer section 153 stores the data set group previously expanded in the register. Further, the data integration result performed as described above is stored (the stored data set group is properly updated by the data integration). As will be described later, in a case where valid data of the register is not able to be fully integrated with the data of the buffer section 153, the data integrating section 152 reads the data set group from the buffer section 153 (arrow 181), and supplies it to the aligning section 154 (arrow 182). Further, the data integrating section 152 reads the data set group from the buffer section 153, and then stores the data set group expanded in the register in the buffer section 153 (arrow 180).

The aligning section 154 rearranges the supplied data set group and divides it into data in which the control information is valid and data in which the control information is invalid (data in which the control information is valid is collected). The aligning section 154 supplies the MQ coding performing section 155 with the data in which the control information is valid (arrow 183).

The MQ coding performing section 155 performs the MQ coding for the supplied data while referring to the probability estimation table 156 defined in the typical JPEG2000 (arrow 184), to thereby generate the coded data. The MQ coding performing section 155 supplies the coded code stream generating section 106 with the generated coded data (arrow 185).

### [Flow of Process]

An example of a flow of a coding process performed by the image coding apparatus 100 will be described with reference to a flowchart of FIG. 10.

If the coding process starts, the wavelet converting section 101 wavelet-transforms image data corresponding to one picture, in step S101. In step S102, the quantization section 102 quantizes coefficient data generated in step S101. In the case of lossless compression, the process of step S102 is omitted.

In step S103, the bit-plane expanding section 103 expands the coefficient data in bit-planes. In step S104, the code blocking section 104 code-blocks the coefficient data.

In step S105, the bit modeling section 111 of the EBCOT 105 performs the bit modeling process. In step S106, the MQ coding section 112 of the EBCOT 105 performs the MQ coding process.

In step S107, the coded code stream generating section 106 aligns the coded data generated in the EBCOT 105 to generate code streams for output. When the process of step S107 is terminated, the coding process is terminated.

The coding process is performed for each picture.

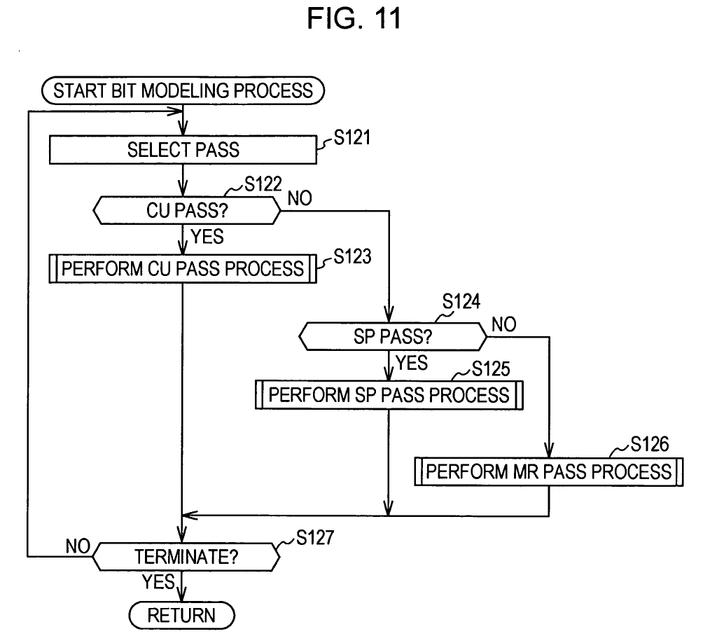

Next, an example of a detailed flow of the bit modeling process performed in step S105 in FIG. 10 will be described with reference to a flowchart in FIG. 11.

If the bit modeling process is started, the selecting section 141 in step S121 selects a coding pass. In step S122, the selecting section 141 determines whether or not the CU pass is selected.

If it is determined that the CU pass is selected, the procedure goes to step S123. In step S123, the CU pass section 142 performs the CU pass process for performing coding by the CU pass. If the CU pass process is terminated, the procedure goes to step S127.

Further, in step S122, if it is determined that the CU pass is not selected, the procedure goes to step S124. In step S124, the selecting section 141 determines whether or not the SP pass is selected.

If it is determined that the SP pass is selected, the procedure goes to step S125. In step S125, the SP pass section 143 performs the SP pass process for performing coding by the SP pass. If the SP pass process is terminated, the procedure goes to step S127.

Further, in step S124, if it is determined that the SP pass is not selected, the procedure goes to step S126. In step S126, the MR pass section 144 performs the MR pass process for performing coding by the MR pass. If the MR pass process is terminated, the procedure goes to step S127.

In step S127, the bit modeling section 111 determines whether or not to terminate the bit modeling process. If it is determined that unprocessed coefficient data exists and the bit modeling process is not to be terminated, the procedure returns to step S121, and the subsequent processes are repeated. Further, if it is determined in step S127 that all coefficient data in the picture is processed, the bit modeling process is terminated, and then the procedure returns to step S105 in FIG. 10, to thereby perform the processes of step S106 and thereafter.

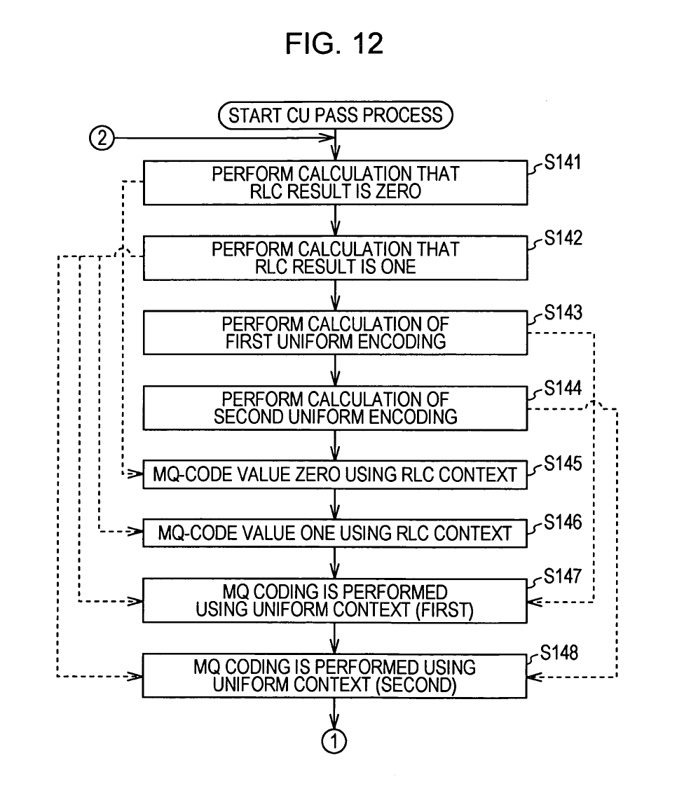

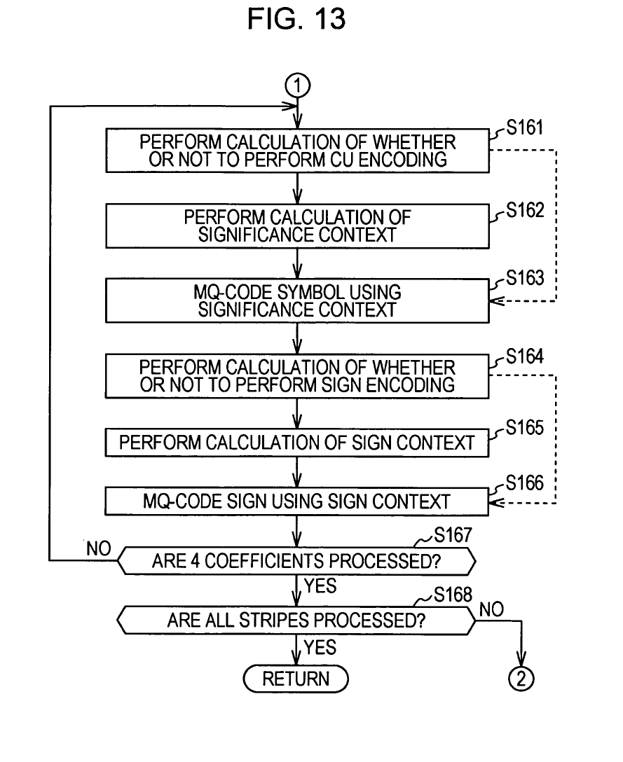

Next, an example of a flow of the CU pass process performed in step S123 in FIG. 11 will be described with reference to flowcharts in FIGS. 12 and 13. It is assumed that the horizontal size of the stripe is 64, and the vertical size thereof is 4. Further, in FIGS. 12 and 13, dashed arrows represent the dependence relation of data.

In the CU pass, while the coefficient group in the stripe in the vertical direction (4 coefficients in the case of the example in FIG. 6) is scanned from the top to the bottom direction, the following calculations (steps S141 to S148) are performed for the coefficient group (4 coefficients).

In step S141, the CU pass section 142 performs a calculation that the result of the run length coding (RLC: Run Length Coding) is zero. When the calculation succeeds, the calculation result becomes 0xFF (hereinafter, referred to as “FF”). Further, when the calculation fails, the calculation result becomes 0x00 (hereinafter, referred to as “00”). These calculation results affect the process of step S145.

When the process of step S141 is terminated, the procedure goes to step S142. In step S142, the CU pass section 142 performs a calculation that the result of the RLC is one. When the calculation succeeds, the calculation result becomes FF. Further, when the calculation fails, the calculation result becomes 00. These calculation results affect the processes of steps S146 to S148.

When the process of step S142 is terminated, the procedure goes to step S143. In step S143, the CU pass section 142 performs a calculation of a first uniform encoding. The encoding target is zero or one. The calculation result affects the process of step S147.

When the process of step S143 is terminated, the procedure goes to step S144. In step S144, the CU pass section 142 performs a calculation of a second uniform encoding. The encoding target is zero or one. The calculation result affects the process of step S148.

In the CU pass process, there is an initial branch point of whether to perform the RLC process or not in step S141. Here, as shown in FIG. 12, in the present embodiment, the calculation that the RLC result is one and the calculation that the RLC result is zero are all performed. Further, using the result (FF or 00), the MQ coding section 112 can automatically determine whether the RLC is valid or not in reality.

When the process of step S144 is terminated, the procedure goes to step S145. The CU pass section 142 supplies the MQ coding section 112 with data (control information, symbols, contexts and the like), so that a value zero is MQ-coded using an RLC context in step S145, and a value one is MQ-coded using the RLC context in step S146.

Further, the CU pass section 142 supplies the MQ coding section 112 with data (control information, symbols, contexts and the like), so that a first MQ coding is performed using a uniform context in step S147, and a second MQ coding is performed using the uniform context in step S148.

If the process of step S148 in FIG. 12 is terminated, the procedure goes to step S161 in FIG. 13. In the CU pass, the following calculations (steps S161 to S166) are performed with respect to each coefficient in the above-described coefficient group (4 coefficients).

In step S161, the CU pass section 142 performs a calculation of whether or not to perform the CU encoding. For example, when the CU encoding is performed, the calculation result becomes FF, and when the CU encoding is not performed, the calculation result becomes 00. The calculation results are used for the MQ coding in step S163.

If the process in step S161 is terminated, the procedure goes to step S162. In step S162, the CU pass section 142 performs a calculation of a significance context. The CU pass section 142 supplies the data (control information, symbols, contexts and the like) to the MQ coding section 112, to thereby MQ-code a symbol using the significance context in step S163.

If the process of step S163 is terminated, the procedure goes to step S164. In step S164, the CU pass section 142 performs a calculation of whether or not to perform a sign encoding. For example, in a case where the sign encoding is performed, the calculation result becomes FF, and in a case where the sign encoding is not performed, the calculation result becomes 00. These calculation results are used for the MQ coding of step S166.

If the process of step S164 is terminated, the procedure goes to step S165. In step S165, the CU pass section 142 performs a calculation of a sign context. The CU pass section 142 supplies the data (control information, symbols, contexts and the like) to the MQ coding section 112, to thereby MQ-code a sign using a sign context in step S166.

In step S167, the CU pass section 142 determines whether all coefficients in the coefficient group (4 coefficients) which is the process target are processed. If it is determined that an unprocessed coefficient exist, the procedure returns to step S161, and then repeats the subsequent processes.

Further, if it is determined in step S167 that all coefficients in the coefficient group (4 coefficients) which is the process target are processed, the procedure goes to step S168. In step S168, the CU pass section 142 determines whether all coefficients of all stripes of the bit-plane which is the process target are processed. If it is determined that an unprocessed coefficient exists, the procedure returns to step S141 in FIG. 12, and repeats the subsequent processes.

Further, if it is determined, in step S168 in FIG. 13, that all coefficients are processed, the CU pass process is terminated. Then, the procedure returns to step S123 in FIG. 11, and the processes of step S127 and thereafter are performed.

In the above CU pass process, for example, the calculation that the RLC result is one is performed (step S142), and in a case where the sign output as the result is FF, this means that the calculation was valid. In this case, even though the calculation that the RLC result is zero is performed (step S141), it is obvious that the calculation result is 00 (invalid) (because the results zero and one are in the antinomy relation).

In addition, in a case where calculation that the RLC result is one is valid, the calculation of the uniform encoding is performed two times. In any case, the encoding target is zero or one. Further, there is a case where RLC is not performed at all, as a case other than the above two cases.

Hereinafter, with respect to three cases, the procedure of performing each process of steps S141 to S148 in FIG. 11 will be described hereinafter.

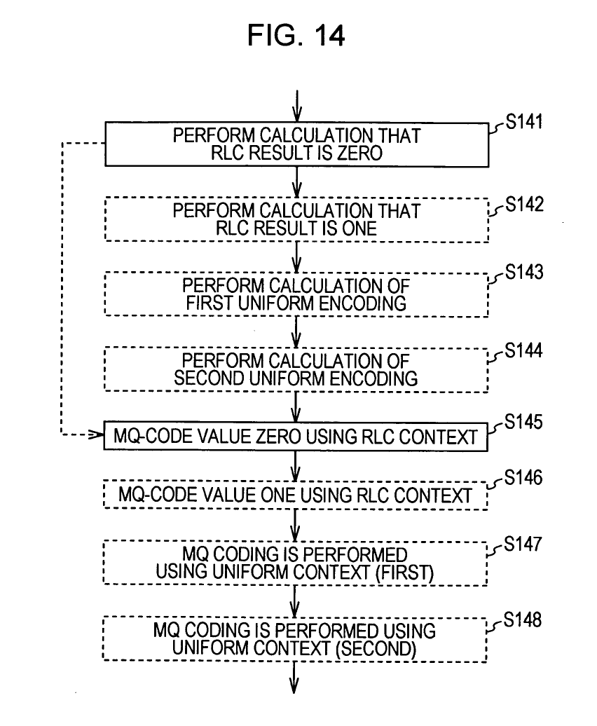

First of all, the process of actually generating an operation in a case where the RLC result is zero will be described with reference to FIG. 14.

<<Case 1 (case where the RLC result is zero)>>

(1) If the calculation that the RLC result is zero is performed (step S141), the result becomes FF.

(2) If the calculation that the RLC result is one is performed (step S142), the result becomes 00.

(3) Even though the calculation of the first uniform encoding is performed (step S143), a code word is not generated.

(4) Even though the calculation of the second uniform encoding is performed (step S144), the code word is not generated.

(5) The value zero is MQ-coded using the RLC context (step S145), and then the code word is output.

(6) Even though the value one is MQ-coded using the RLC context (step S146), the code word is not generated.

(7) Even though the MQ coding is performed using the (first) uniform context (step S147), the code word is not generated.

(8) Even though the MQ coding is performed using the (second) uniform context (step S148), the code word is not generated.

As described above, in the case of Case 1, with respect to a sample in which the RLC result is zero, the value zero is MQ-coded using the RLC context. At this time, three pieces of data of the RLC context, the symbol (0) and the control information (FF) are input to the MQ coding section 112.

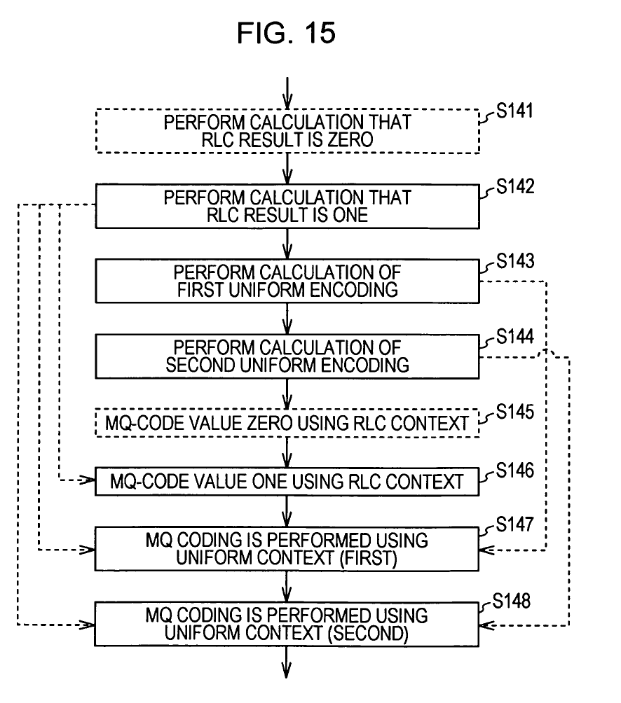

Next, the process of actually generating an operation in a case where the RLC result is one will be described with reference to FIG. 15.

<<Case 2 (Case where the RLC Result is One)>>

(1) If the calculation that the RLC result is zero is performed (step S141), the result becomes 00.

(2) If the calculation that the RLC result is one is performed (step S142), the result becomes FF.

(3) The calculation of the first uniform encoding is performed (step S143), and then the code word is generated.

(4) The calculation of the second uniform encoding is performed (step S144), and then the code word is generated.

(5) Even though the value zero is MQ-coded using the RLC context (step S145), the code word is not generated.

(6) The value one is MQ-coded using the RLC context (step S146), and then the code word is output.

(7) The MQ coding is performed using the (first) uniform context (step S147), and then the code word is output.

(8) The MQ coding is performed using the (second) uniform context (step S148), and then the code word is output.

As described above, in the case of Case 2, with respect to a sample in which the RLC result is one, the value one is MQ-coded using the RLC context. At this time, since the first and second uniform encodings are simultaneously performed, the value zero or one is MQ-coded using each uniform context. Accordingly, in Case 2, three MQ coding operations are performed, and data input to the MQ coding section 112 are the RLC context, the symbol (1) and the control information (FF); the first uniform context, the symbol (0 or 1) and the control information (FF); or the second uniform context, the symbol (0 or 1) and the control information (FF).

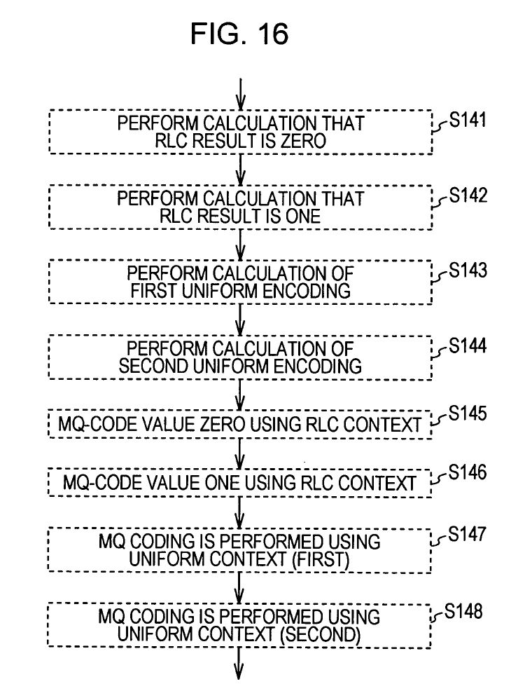

Next, the process of actually generating an operation in a case where the RLC is not performed will be described with reference to FIG. 16.

<<Case 3 (Case where the RLC is not Performed)>>

(1) If the calculation that the RLC result is zero is performed (step S141), the result becomes 00.

(2) If the calculation that the RLC result is one is performed (step S142), the result becomes 00.

(3) Even though the calculation of the first uniform encoding is performed (step S143), the code word is not generated.

(4) Even though the calculation of the second uniform encoding is performed (step S144), the code word is not generated.

(5) Even though the value zero is MQ-coded using the RLC context (step S145), the code word is not generated.

(6) Even though the value one is MQ-coded using the RLC context (step S146), the code word is not generated.

(7) Even though the MQ coding is performed using the (first) uniform context (step S147), the code word is not generated.

(8) Even though the MQ coding is performed using the (second) uniform context (step S148), the code word is not generated.

As described above, in the case where the RLC is not performed, each process of steps S141 to S148 is performed, but the process of actually generating the code word does not exist. This is the same as in the case where the RLC is not performed in the CU pass process in the related art.

In addition, as described above, in the EBCOT 105, no conditional branch is generated in the processes for each coefficient (steps S161 to S166 in FIG. 13). Thus, the EBCOT 105 can perform the coding at a high speed compared with the related art method.

Further, in a case where the calculation result of whether or not to perform the CU encoding is FF, a symbol of the sample is MQ-coded using the significance context. In a similar way, in a case where the result of whether or not to perform the sign encoding is FF, a symbol of the sample is MQ-coded using the sign context.

As described above, in a case where the CU pass is selected in the bit modeling section 111 in FIG. 8, any one data group (contexts, symbols and control information) of the above Case 1 to Case 3 is expanded in the register with respect to the stripe, and the significance and sign information (contexts, symbols and control information) are expanded in the register for each symbol.

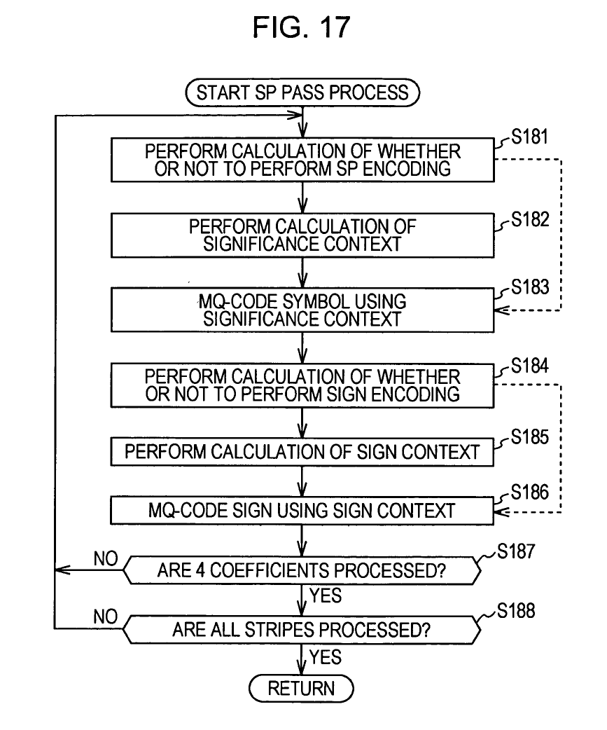

Next, an example of a flow of the SP pass process performed in step S125 in FIG. 11 will be described with respect to a flowchart in FIG. 17. Dashed arrows represent the dependence relation of data.

If the SP pass process starts, the SP pass section 143 calculates whether or not to perform the SP encoding in step S181. For example, in a case where the SP encoding is performed, the calculation result becomes FF, and in a case where the SP encoding is not performed, the calculation result becomes 00. These calculation results are used for the MQ coding in step S183.

If the process of step S181 is terminated, the procedure goes to step S182. In step S182, the SP pass section 143 calculates a significance context. In step S183, the SP pass section 143 supplies data (control information, symbols, contexts and the like) to the MQ coding section 112, to thereby MQ-code the symbol using the significance context.

If the process of step S183 is terminated, the procedure goes to step S184. In step S184, the SP pass section 143 calculates whether the coefficient is one or not. For example, in a case where the coefficient is one, the calculation result becomes FF, and in a case where the coefficient is zero, the calculation result becomes 00. The calculation results are used for the MQ coding of step S186.

If the process of step S184 is terminated, the procedure goes to step S185. In step S185, the SP pass section 143 calculates a sign context. In step S186, the SP pass section 143 supplies data (control information, symbols, contexts and the like) to the MQ coding section 112, to thereby MQ-code the sign using the sign context.

In step S187, the SP pass section 143 determines whether all coefficients in the coefficient group (4 coefficients) which is the process target are processed. If it is determined that an unprocessed coefficient exists, the procedure returns to step S181, and repeats the subsequent processes.

If it is determined in step S187 that all coefficients in the coefficient group (4 coefficients) which is the process target are processed, the procedure goes to step S188. In step S188, the SP pass section 143 determines whether all coefficients of all stripes in a bit-plane which is a process target are processed. If it is determined that an unprocessed coefficient exists, the procedure returns to step S181, and repeats the subsequent processes.

Further, in step S188, if it is determined that all coefficients are processed, the SP pass process is terminated. Then, the procedure returns to step S125 in FIG. 11, and the processes of step S127 and thereafter are performed.

In the case of the SP pass process, in a similar way to the case of the CU pass, any conditional branch is not generated in the process (steps S181 to S186 in FIG. 17) for each coefficient. Thus, the EBCOT 105 can perform coding at a high speed compared with the related art method.

Further, in a case where the calculation result of whether or not to perform the SP encoding is FF, a symbol of the sample is MQ-coded using the significance context. Similarly, in a case where the calculation result of whether or not to perform the sign encoding is FF, a symbol of the sample is MQ-coded using the sign context.

As described above, in a case where the SP pass is selected in the bit modeling section 111 in FIG. 8, the significance and sign information (contexts, symbols and control information) is expanded in the register for each sample, without generating codes for the stripe.

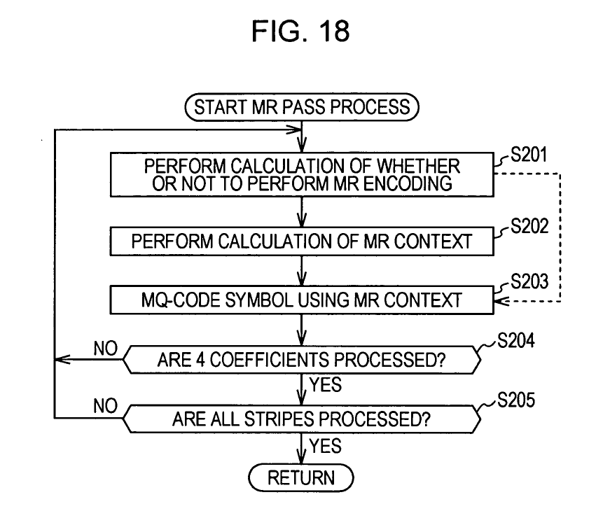

Next, an example of a flow of the MR pass process performed in step S126 in FIG. 11 will be described with a flowchart in FIG. 18. A dashed arrow represents the dependence relation of data.

If the MR pass process starts, in step S201, the MR pass section 144 performs a calculation of whether or not to perform the MR encoding. For example, in a case where the MR encoding is performed, the calculation result becomes FF, and in a case where the MR encoding is not performed, the calculation result becomes 00. The calculation results are used for the MQ coding of step S203.

If the process of step S201 is terminated, the procedure goes to step S202. In step S202, the MR pass section 144 performs a calculation of an MR context. In step S203, the SP pass section 143 supplies data (control information, symbols, contexts and the like) to the MQ coding section 112, to thereby MQ-code the symbol using the MR context.

If the process of step S203 is terminated, the procedure goes to step S204. In step S204, the MR pass section 144 determines whether all coefficients in the coefficient group (4 coefficients) which is the process target are processed. If it is determined that an unprocessed coefficient exists, the procedure returns to step S201, and then repeats the subsequent processes.

If it is determined in step S204 that all coefficients in the coefficient group (4 coefficients) which is the process target are processed, the procedure goes to step S205. In step S205, the MR pass section 144 determines whether all coefficients of all stripes in a bit-plane which is the process target are processed. If it is determined that an unprocessed coefficient exists, the procedure returns to step S201, and then repeats the subsequent processes.

Further, in step S205, if it is determined that all coefficients are processed, the MR pass process is terminated. Then, the procedure returns to step S126 in FIG. 11, and then the processes of step S127 and thereafter are performed.

In the case of the MR pass process, in a similar way to the cases of the CU pass or SP pass, any conditional branch is not generated in the processes (steps S201 to S203 in FIG. 18) for each coefficient. Thus, the EBCOT 105 can perform the coding at a high speed compared with the related art method.

In addition, in a case where the calculation result of whether or not to perform the MR encoding is FF, a symbol of the sample is MQ-coded using the MR context.

As described above, in a case where the MR pass is selected in the bit modeling section 111 in FIG. 8, the MR data (contexts, symbols and control information) is expanded in the register for each sample, without generating codes for the stripe.

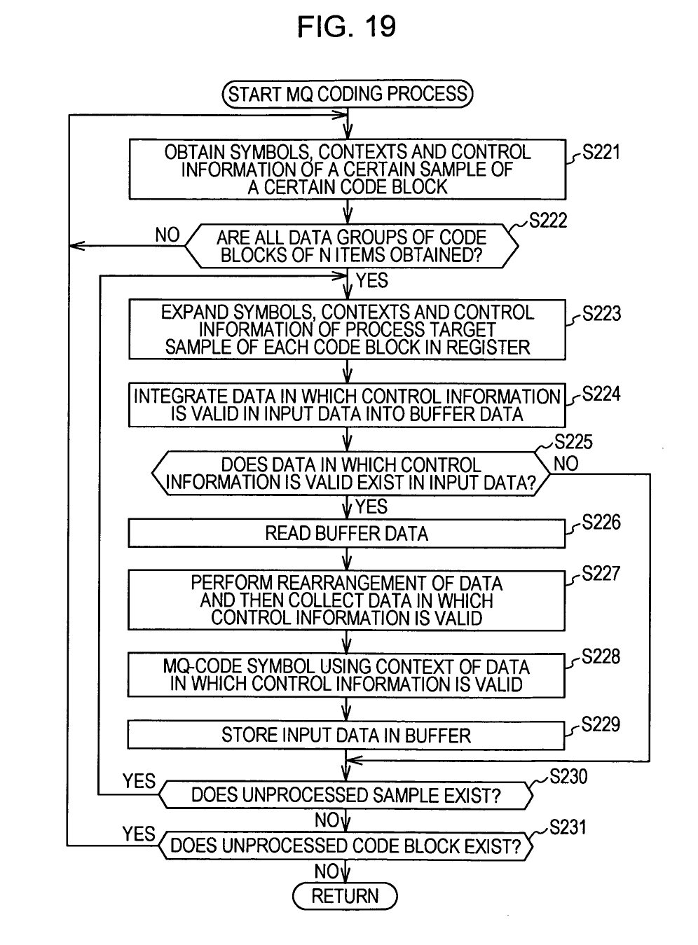

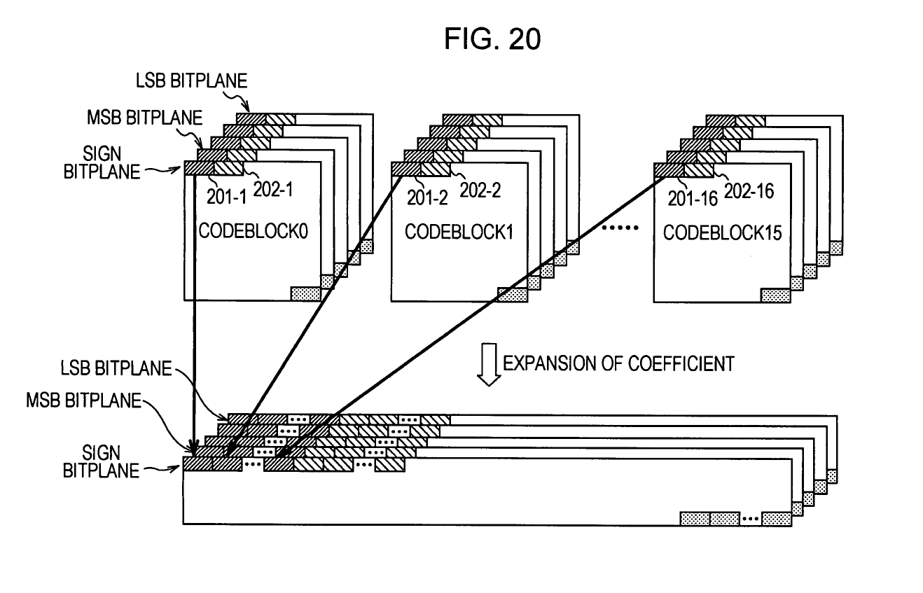

Next, an example of a flow of the MQ coding process performed in step S106 in FIG. 10 in correspondence with the process of each coding pass as described above will be described with reference to a flowchart in FIG. 19. Description will be made with reference to FIGS. 20 to 25, as necessary.

The MQ coding section 112 in FIG. 8 performs the MQ coding process, to thereby perform the MQ coding for data set (control information, symbols, contexts and the like) supplied by each process of steps S145 to S148 in FIG. 12, steps S163 and S166 in FIG. 13, steps S183 and S186 in FIG. 17, and step S203 in FIG. 18, for example.

If the MQ coding process starts, the register expanding section 151 obtains a data set such as symbols, contexts, control information and the like of a certain sample of a certain code block, supplied from the bit modeling section 111 in step S221.

In step S222, the register expanding section 151 determines whether the data set is obtained for all samples (coefficients) of code blocks of a predetermined number (N items (N is a natural number)) which are determined in advance. If it is determined that the data set corresponding to the code blocks of the predetermined number (N) is not obtained, the procedure returns to step S221, and then repeats the subsequent processes.

In step S222, if it is determined that the data set is obtained for all samples of the code blocks of the predetermined value (N), the procedure goes to step S223.

In step S223, the register expanding section 151 obtains the data set of symbols, contexts and control information of a process target sample from each of the code blocks of the predetermined number in which the data group is obtained, and then expands it in the register. The data set group expanded in the register is referred to as input data.

FIG. 20 is a diagram illustrating the expansion of the data set group in the register. In the case of the example shown in FIG. 20, a data set group is obtained for 16 code blocks ranging from a codeblock0 to a codeblock15, and is expanded in the register as shown in the lower section in FIG. 20.

In the example of FIG. 20, a data set group of samples in the same positions of the respective code blocks is read for every bit-plane, and is arranged in the register.

For example, in a sign bit-plane, a data set 201-1 of a sample on the upper left side is read from the codeblock0, and a data set 201-2 of a sample on the upper left side is read from the codeblock1. Similarly, a data set is read from the codeblock3 to the codeblock14, and a data set 201-16 of a sample on the upper left side is read from the codeblock15. The data set 201-1 to the data set 201-16 are arranged in parallel in the register.

Further, as will be described later, if the input data of the register is processed, a neighboring data set 202-1 of a sample on the right side is read from the codeblock0, and a neighboring data set 202-2 of a sample on the right side is also read from the codeblock1. Similarly, a neighboring data set of a sample on the right side is read from the codeblock3 to the codeblock14, and a neighboring data set 202-16 of a sample on the right side is read from the codeblock15. The data set 202-1 to the data set 202-16 are arranged in parallel in the register, in a similar way to the data set 201-1 to the data set 201-16.

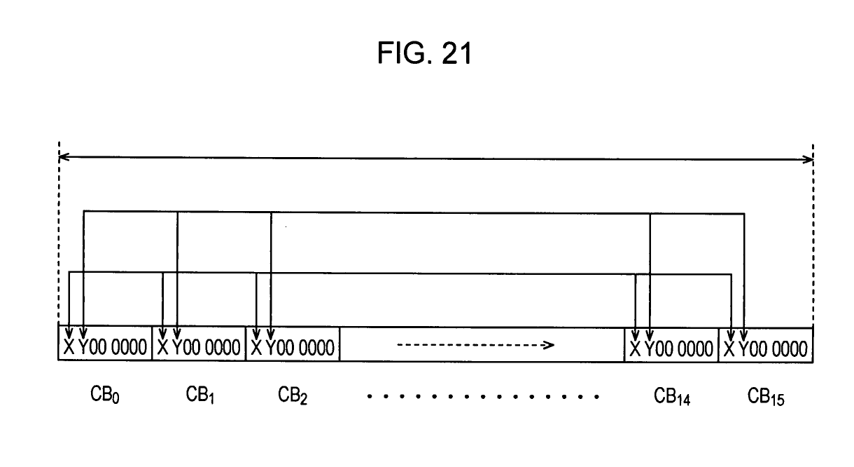

The input data is processed in a similar way to the case of the data set 201-1 to the data set 201-16. That is, for example, as shown in FIG. 21, in each of 16 code blocks of CB₀ to CB₁₅, respective samples such as a sample X, a sample Y, a sample 0, a sample 0, and so on are processed in the same order.

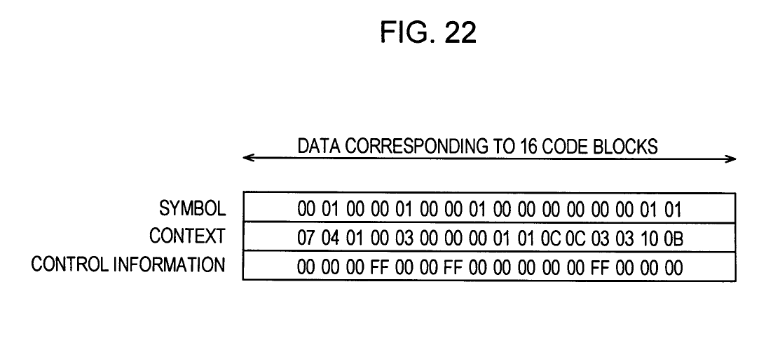

FIG. 22 is a diagram illustrating an example of input data which is expanded in the register.

As shown in FIG. 22, symbols, contexts and control information of samples in the same positions of 16 code blocks are arranged in the register. Accordingly, assuming that the number of the code blocks is N (N is a natural number) and one piece of data is 1 byte, the length of the register becomes (3×N) bytes, which is very small.

Returning to FIG. 19, if the input data is expanded in the register as described above, in step S224, the data integrating section 152 integrates data in which the control information is valid, among the input data expanded in the register, in a data group (buffer data) stored in the buffer section 153.

In this respect, problems of the MQ coding in the related art will be described. If data on symbols and contexts in which the control information is invalid is generally encoded by the MQ coding, the code word is not generated. Accordingly, in the case of the example in FIG. 22, the encoding becomes useless for 13 pieces of invalid data among 16 pieces of data. Thus, it is efficient to remove the invalid data in advance or to separate it from the encoding target.

Then, the data integrating section 152 firstly integrates the input data and the buffer data, to thereby make the valid data intensive (to increase the density of the valid data).

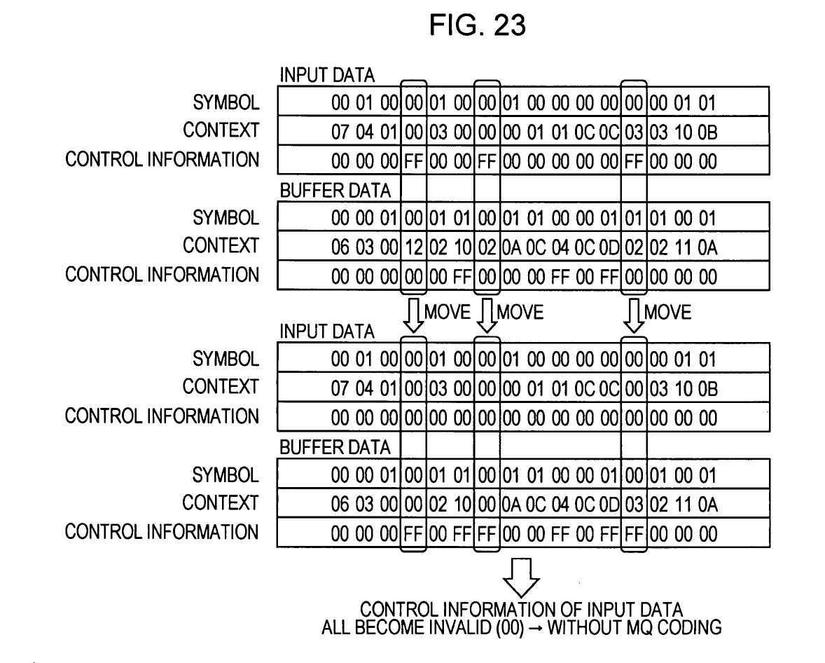

FIG. 23 illustrates an example of the integrated data. In FIG. 23, the upper section above arrows in the center in the figure represents a state of the input data and the buffer data when expanded in the register.

In the upper sections, the data integrating section 152 firstly searches data in which the control information is invalid (00) in the buffer data, and then detects data in which the control information is valid (FF) in the input data in the same position. In the case of the example in FIG. 23, three samples in fourth, seventh and thirteenth positions from the left end correspond to this data.

Further, the data integrating section 152 moves (integrates) the data on the symbols and contexts of the input data in these positions, into the buffer data. In FIG. 23, the lower section under the arrows in the center in the figure represents a state of the input data and the buffer data after data integration.

As shown in the lower section in FIG. 23, in the buffer data of the position in which the movement is performed, the data in which the control information is valid (FF), which has existed in the input data in the upper section, is arranged.

As a result, the input data in the position where the movement is performed becomes empty. That is, it becomes data in which the control information is invalid (00). In the case of the example in FIG. 23, the control information of 16 samples of the input data entirely becomes invalid. Accordingly, it is not necessary to MQ-code the input data, and it is possible to destroy the input data. That is, according to the data integration as described above, the MQ coding performing section 155 can omit one-time MQ coding process, reduce the calculation load of the MQ coding, and perform the MQ coding more efficiently.

In reality, the integration of the input data expanded in the register with the buffer data is similarly performed. That is, since the data integrating section 152 integrates data to a maximum extent, the MQ coding performing section 155 can enhance the efficiency of the MQ coding.

Returning to FIG. 19, in step S225, the data integrating section 152 determines whether data in which the control information is valid exists in the input data. If it is determined that the data exists, the procedure goes to step S226.

In step S226, the data integrating section 152 reads the buffer data from the buffer section 153.

In the case of the example in FIG. 24, the data in which the control information is valid exists in the input data after the data integration. In FIG. 24, the input data in a first stage from the top and the buffer data in a second stage from the top illustrate a state before the integration, and the input data in a third stage from the top and the buffer data in a fourth stage from the top illustrate a state after the integration.

In the state before the data integration, the control information of the fourth, seventh and thirteenth samples is valid in the input data, but since the control information of the thirteenth sample of the buffer data is invalid, the data integration is possible in a similar way to the case in FIG. 23, with respect to this position.

In this respect, since the control information of the fourth and seventh samples of the buffer data is valid, and thus, it is not possible to integrate the input data and the buffer data in these positions.

Accordingly, even in the state after the data integration, the control information of the fourth and seventh samples of the input data remains valid (FF), and thus, it is not possible to destroy the input data.

Accordingly, in this case, the data integrating section 152 reads this buffer data and then MQ-codes it. Further, as shown in the lowest stage in FIG. 24, the data integrating section 152 stores the input data in the buffer section 153 and then uses it as new buffer data. Next, the input data expanded in the register is integrated with this buffer data.

Returning to FIG. 19, in step S227, the aligning section 154 performs rearrangement of the buffer data read from the buffer section 153 and then collects data in which the control information is valid.

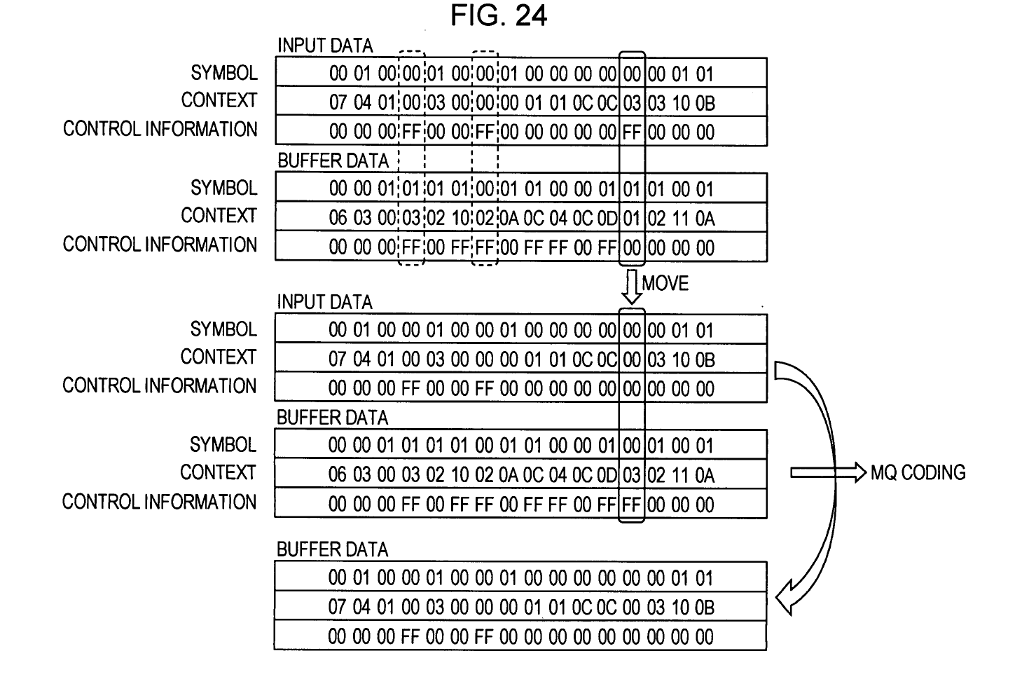

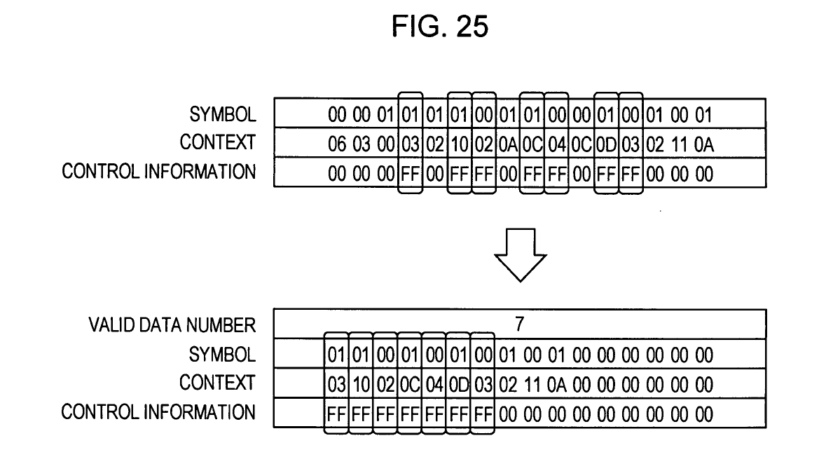

FIG. 25 is a diagram illustrating an example of the alignment of this data. The upper stage in FIG. 25 illustrates a state when read from the buffer section 153. The aligning section 154 collects data of samples in which the control information is valid, for example, on the left side, as shown in the lower stage in FIG. 25, in the input data (separates the data in which the control information is valid from the data in which the control information is invalid).

Here, as shown in FIG. 25, information about a valid data number indicating the number of data items in which the control information is valid is added to a data group in which the order is rearranged. Further, since it is necessary to return the rearranged order to the original order at the time of code streaming in reality, information on the original position (address) of the data in which the control information is valid is managed.

Returning to FIG. 19, in step S228, the MQ coding performing section 155 MQ-codes, with respect to each data item in which the control information is valid, the symbol using the corresponding context.

In the case of the example in FIG. 25, the MQ coding performing section 155 may MQ-code the data group corresponding to the number of valid data items from the left side. In this way, the MQ coding performing section 155 can appropriately omit coding of data in which the control information is invalid, and can perform the MQ coding more efficiently.

Returning to FIG. 19, the data integrating section 152 supplies the input data in the register to the buffer section 153 and stores it, in step S229. If the process of step S229 is terminated, the procedure goes to step S230. Further, if it is determined in step S226 that the data in which the control information is valid does not exist in the input data, the procedure goes to step S230.

In step S230, the register expanding section 151 determines whether an unprocessed sample exists for the obtained code blocks of a predetermined number. If it is determined that the unprocessed sample exists, the procedure returns to step S223 and then repeats the subsequent processes.

Further, in step S230, if it is determined that the unprocessed sample does not exist, the procedure goes to step S231. In step S231, the register expanding section 151 determines whether the unprocessed code block exists in the picture. If it is determined that the unprocessed code block exists, the procedure returns to step S221 and then repeats the subsequent processes.

Further, in step S231, if it is determined that the unprocessed code block does not exist, the MQ coding process is terminated. Then, the procedure returns to step S106 in FIG. 10, and performs the processes of step S107 and thereafter.

As described above, the data integrating section 152 integrates the data and collects the data in which the control information is valid, and the aligning section 154 performs the rearrangement of the data and collects the data in which the control information is valid, so that the MQ coding performing section 155 can omit the MQ coding of the data in which the control information is invalid, to thereby more efficiently perform the MQ coding.

Thus, the image coding apparatus 100 can perform the coding at a higher speed.

The number of the buffer data items stored in the buffer section 153 is arbitrary. That is, a plurality of pieces of buffer data may be provided. In this way, the integration of the input data with the buffer data becomes easier.

For example, as shown in an example in FIG. 24, even in a case where the data in which the control information is valid, which is not able to be integrated with the buffer data, exists in the input data, there is possibility of integration with other buffer data.

If the number of the buffer data items is increased, the possibility becomes high. However, the number of the buffer data items is increased, the capacity of the buffer section 153 is increased. That is, an optimal number of the buffer data items is determined according to the intensity of the data in which the control information is valid and, for example, the trade-off with cost or the like.

### 2. Second Embodiment

### Configuration of Image Coding Apparatus

In the above description, the MQ coding performing section 155 MQ-codes each data in which the control information is valid, which is read from the buffer section 153. However, the MQ coding for the plurality of samples may be performed in parallel so that the coding process can be performed at a high speed.

However, since there are various types of code blocks in the picture, it is efficient to collect similar code blocks in advance and to encode them at one time.

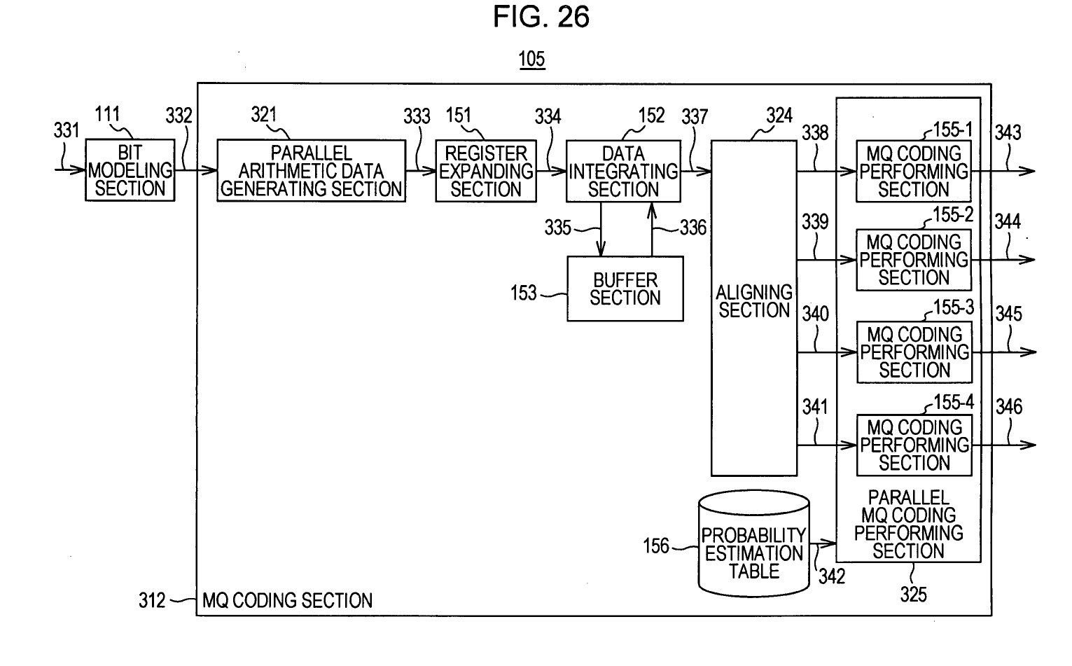

FIG. 26 is a block diagram illustrating another example of a configuration of the EBCOT 10.5 according to an embodiment of the present invention. The EBCOT 105 shown in FIG. 26 basically has the same configuration as in the case of FIG. 8, but has an MQ coding section 312, instead of the MQ coding section 112 in FIG. 8.

The MQ coding section 312 performs the MQ coding process in a similar way to the MQ coding section 112. However, unlike the case of MQ coding section 112, the MQ coding section 312 performs a plurality of MQ coding processes for data group of different samples in parallel.

The MQ coding section 312 basically has the same configuration as the MQ coding section 112, but has an aligning section 324 instead of the aligning section 154, and has a parallel MQ coding performing section 325 instead of the MQ coding performing section 125, and further has a parallel arithmetic data generating section 321.

The parallel arithmetic data generating section 321 makes code block groups according to parameters indicating characteristics of code blocks so as to perform calculation (MQ coding) in parallel, and supplies the data group of each code block for each group to the register expanding section 151.

That is, as described above, a data group of a plurality of code blocks is input to the register expanding section 151, but the parallel arithmetic data generation section 321 performs a control so that the plurality of code blocks becomes code blocks having the same parameters (characteristics).

The parallel arithmetic data generating section 321 stores data groups supplied (arrow 332) from the bit modeling section 111, groups the data groups for each code block, and then supplies data for each group to the register expanding section 151 (arrow 333).

As the parameters, anything indicating the characteristics of the code blocks may be used, which may include, for example, a horizontal size (h_size) of the code block, a vertical size (v_size) of the code block, sub-band types (LL, HL, LH and HH) and the number of coding passes (num_pass) calculated as will be described later. For example, the coding pass number (num_pass) is calculated as the above-described formula (1). Of course, other parameters may be included.

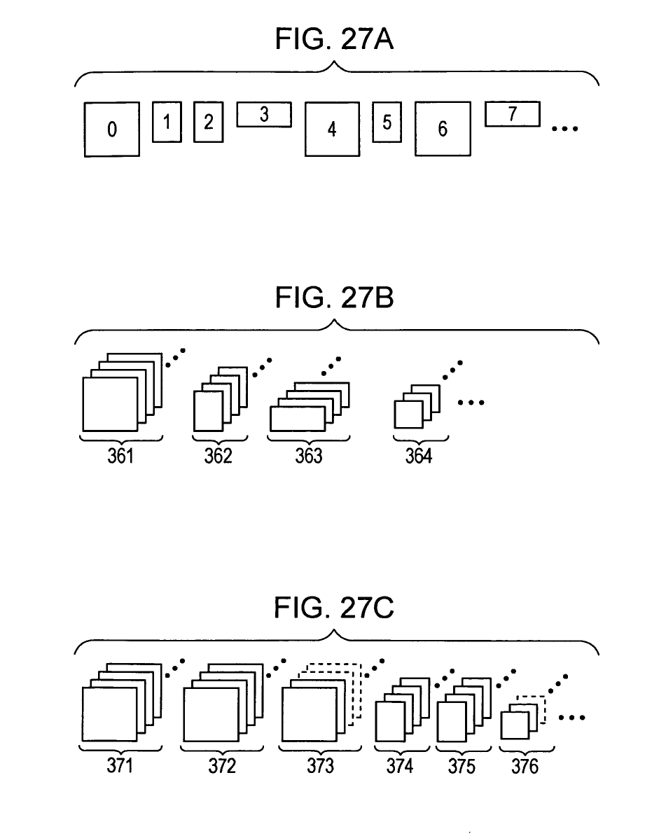

Like an example shown in FIG. 27A, the sizes (horizontal and vertical sizes) of the code blocks in the picture are not all the same. As described above, the code blocking is basically performed to be the same size (basic size), but the basic size may not be secured in opposite ends, upper and lower ends or the like of the image (sub-band). The size of the code blocks in such a portion is smaller than the basic size.

Further, as described above, since the code blocking is performed for the coefficient data, the sub-bands to which each code block in the picture belongs are not all the same. Further, since the numbers of zero bit-planes (number of valid bit-planes) are independent of each other in respective code blocks, the numbers of the coding passes may be different from each other in the respective code blocks.

The parallel arithmetic data generating section 321 compares parameter values of each code block in the picture, and groups the code blocks in which all values are the same, as shown in FIG. 27B.

In FIG. 27B, group 361 to group 364 are code block groups sorted according to the parameters in this way. In other words, all parameter values of all code blocks are the same in each group.

The parallel arithmetic data generating section 321 appropriately divides the groups sorted according to the parameters so that each group is formed by 16 code blocks to the maximum. A group 371 to a group 376 shown in an example in FIG. 27C is a part of groups obtained by further dividing each block in FIG. 27B so that the number of the code blocks becomes 16 to the maximum. For example, the groups 371 to 373 in FIG. 27C are obtained by further dividing the group 361 in FIG. 27B, and the groups 374 and 375 in FIG. 27C are obtained by further dividing the group 362 in FIG. 27B. The group 376 in FIG. 27C corresponds to the group 364 in FIG. 27B, but since the number of the code blocks which belongs to the group 364 is 16 or less, the group 376 has the same number of the code blocks as the group 364.

In a case where the number of the code blocks in the group is less than 16, the parallel arithmetic data generating section 321 complements dummy data (for example, zero value) as a countermove (the number of the code blocks becomes 16 in a pseudo manner).

The register expanding section 151 accumulates code blocks for every group, and then expands the data groups in the register. At this time, values of parameters (horizontal size, vertical size, coding pass number (valid bit-plane number) and sub-band type) of the code blocks which belong to the same group are all the same as each other. Accordingly, each code block has a data configuration in which parallelization is the easiest, and each sample (each data group) expanded in the register can be MQ-coded in the same method. The number of the code blocks in one group is arbitrary.

Returning to FIG. 26, the register expanding section 151, the data integrating section 152 and the buffer section 153 operate in a similar way to the case in FIG. 8. Further, the aligning section 324 basically operates in a similar way to the aligning section 154 in FIG. 8, performs the rearrangement of the data, and then collects the data in which the control information is valid.

As shown in FIG. 26, the parallel MQ coding performing section 325 has an MQ coding performing section 155-1 to an MQ coding performing section 155-4. The MQ coding performing sections 155-1 to 155-4 are respectively the same processing sections as the MQ coding performing section 155 in FIG. 8, and operate in the same manner. That is, the parallel MQ coding section 325 can perform the MQ coding in parallel by 4 to the maximum.

The aligning section 324 distributes the data in which control information is valid to the MQ coding performing sections 155-1 to 155-4 (arrow 338 to arrow 341).

The MQ coding performing sections 155-1 to 155-4 perform the MQ coding while referring to the probability estimation table 156 (arrow 342) with respect to the supplied data, respectively. The MQ coding performing sections 155-1 to 155-4 supply the generated code words to the coded code stream generating section 106, respectively (arrow 343 to arrow 346).

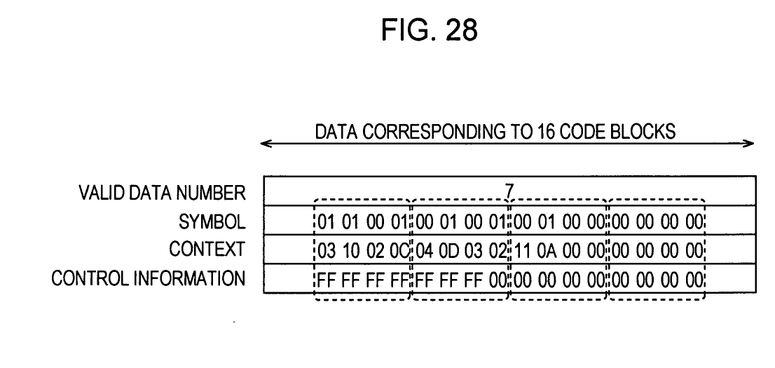

That is, as shown in FIG. 28, the rearranged data groups are MQ-coded by four in parallel, as indicated by dashed lines. That is, the MQ coding section 312 can perform the MQ coding at a higher speed. Further, since only a valid MQ coding is performed in principle, it is possible to omit unnecessary processes.

The parallel number of the MQ coding is arbitrary.

### [Flow of Process]

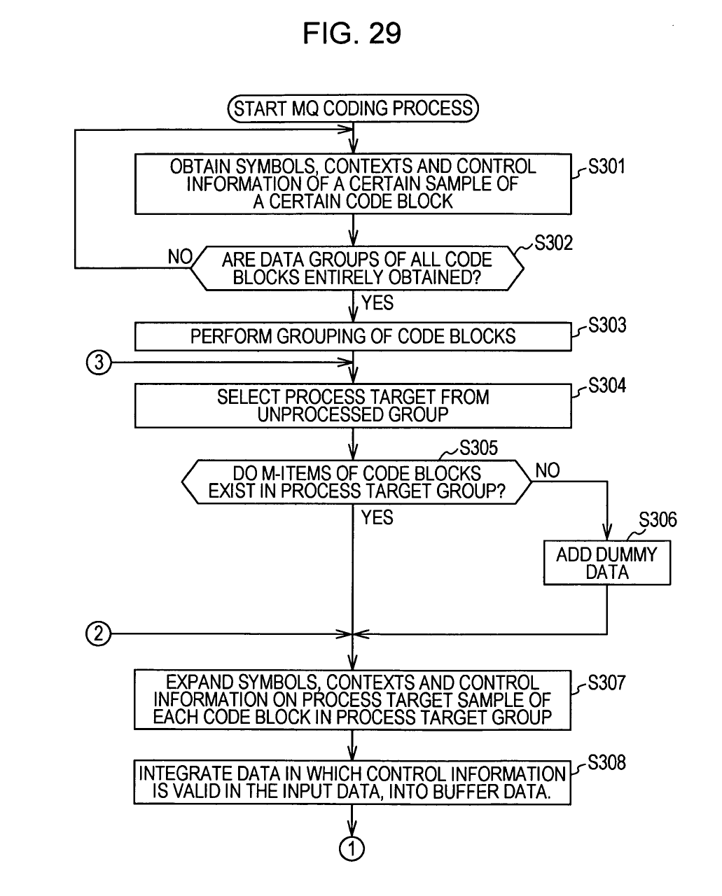

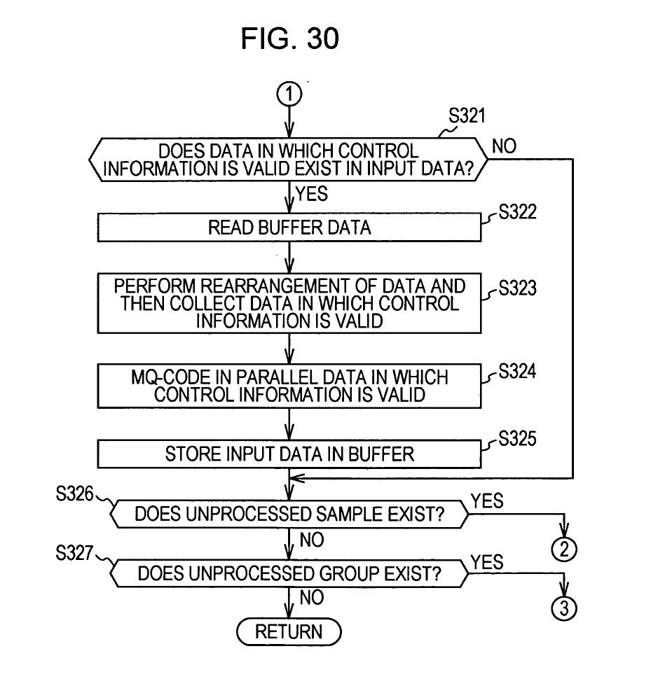

An example of a flow of the MQ coding process as described above will be described with reference to flowcharts of FIGS. 29 and 30. This process corresponds to the MQ coding process described with reference to the flowchart in FIG. 19.

If the MQ coding process starts, in step S301, the parallel arithmetic data generating section 321 obtains a data group such as symbols, contexts and control information or the like of a certain sample of a certain block which is supplied from the bit modeling section 111.

In step S302, the parallel arithmetic data generating section 321 determines whether the data groups of all code blocks in the picture are entirely obtained. If it is determined that the data groups are not entirely obtained, the procedure goes to step S301 and then repeats the subsequent processes.

In step S302, if it is determined that the data groups for the all samples of the all code blocks are obtained, the procedure goes to step S303.

In step S303, the parallel arithmetic data generating section 321 performs the grouping of the code blocks on the basis of parameters of the respective code blocks. In step S304, the parallel arithmetic data generating section 321 selects a process target from an unprocessed group.

In step S305, the parallel arithmetic data generating section 321 determines whether the code blocks of a predetermined number (M items (M is a natural number)) exist in the process target group. If it is determined that the code blocks of the predetermined number (M) exist in the process target group, the procedure goes to step S307. If it is determined that the code blocks of the predetermined number (M) do not exist in the process target group, the procedure goes to step S306. In step S306, the parallel arithmetic data generating section 321 adds dummy data (for example, all zero data) corresponding to the number of the code blocks which is lacking for the predetermined number (M items), to the process target group. If the process of step S306 is terminated, the procedure goes to step S307.

In step S307, the register expanding section 151 expands the symbols, contexts and control information of the process target sample of each code block in the process target group in the register. The data group expanded in the register is referred to as “input data”.

In step S308, the data integrating section 152 integrates data in which the control information is valid, among the input data expanded in the register, into a data group (buffer data) stored in the buffer section 153. If the process of step S308 is terminated, the procedure goes to step S321 in FIG. 30.

In step S321, the data integrating section 152 determines whether data in which the control information is valid exists in the input data after the integration. If it is determined that the data exists in the input data after the integration, the procedure goes to step S322. In step S322, the data integrating section 152 reads the buffer data from the buffer section 153.

In step S323, the aligning section 324 performs rearrangement of the buffer data read from the buffer section 153, and then collects the data in which the control information is valid. In step S324, the parallel MQ coding performing section 325 MQ-codes the respective data in which the control information is valid, in parallel.

In step S325, the data integrating section 152 supplies the input data of the register to the buffer section 153 for storage. If the process of step S325 is terminated, the procedure goes to step S326. Further, if it is determined in step S321 that the data in which the control signal is valid does not exist in the input data, the procedure goes to step S326.

In step S326, the register expanding section 151 determines whether an unprocessed sample exists for the code blocks which belong to the process target group. If it is determined that the unprocessed sample exists, the procedure returns to step S307 in FIG. 29 and then repeats the subsequent processes.

Further, in step S326 in FIG. 30, if it is determined that the unprocessed sample does not exist, the procedure goes to step S327. In step S327, the parallel arithmetic data generating section 321 determines whether the unprocessed group exists in the picture. If it is determined that the unprocessed group exists, the procedure returns to step S304 in FIG. 29, and then repeats the subsequent processes.

Further, in step S327 in FIG. 30, if it is determined that the unprocessed group does not exist, the MQ coding process is terminated. Then, the procedure returns to step S106 in FIG. 10, and then the processes of step S107 and thereafter are performed.

As described above, the MQ coding section 312 can perform a plurality of MQ coding processes in parallel, and can perform the MQ coding more efficiently, compared with the case of the MQ coding section 112. Thus, the image coding apparatus 100 can perform the coding at a higher speed. Further, since only a valid MQ coding is performed in principle, it is possible to omit unnecessary processes.

### Application Example

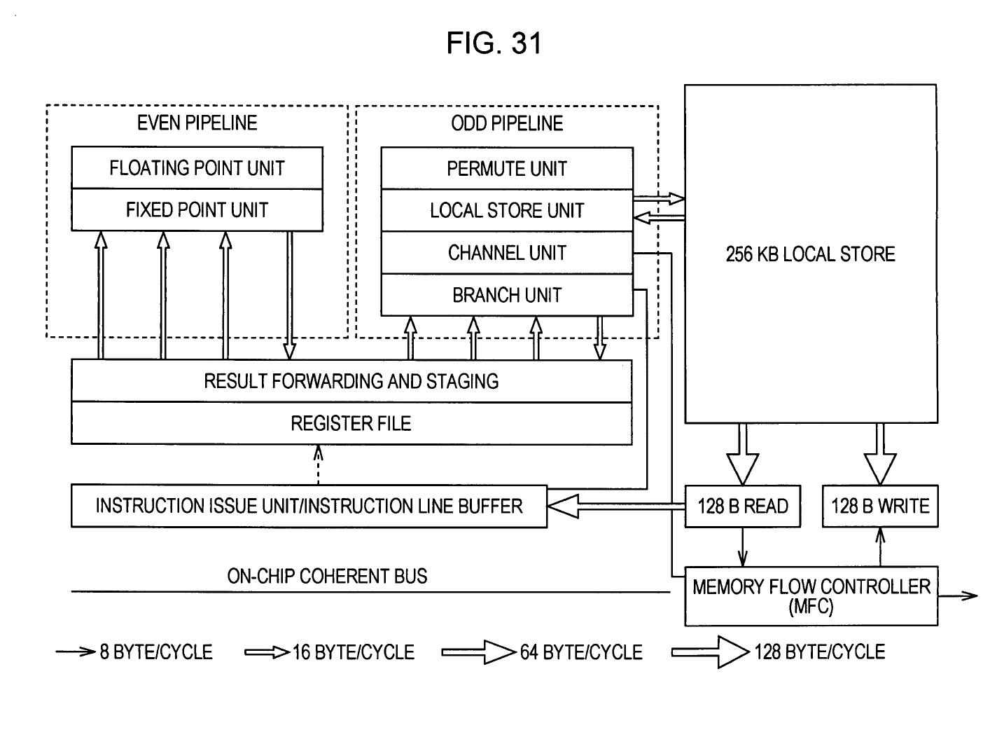

The length of the register of expanding the data is arbitrary. Generally, the length of a data register of a computer or hardware is determined at an initial design stage. That is, the register length mainly depends on the specification of the hardware. FIG. 31 is a diagram illustrating a configuration example of hardware to which the image coding apparatus is applied.

The configuration shown in FIG. 31 is a configuration of SPE (Synergistic Processing Elements) which has 8 sub-processors existing in a processor referred to as “CBE (Cell Broadband Engine)”. As shown in FIGS. 27A to 27C, the SPE is configured so that reading or writing (Read/Write) in the unit of 128 bits is possible for a local storage (cache memory) of 256 KB. That is, this corresponds to the register length of 128 bits.

In the MQ coding section 312 shown in FIG. 26, the number (N) of the code blocks of expanding the data in the register, and the number (M) of parallels (the number of the MQ coding performing sections 155 belonging to the parallel MQ coding performing section 325) which can be performed by the parallel MQ coding performing section 325 are arbitrary, respectively, which may be different values or may be the same values as each other (N and M are natural numbers).

Further, in the bit modeling section 111, the bit modeling may be parallelized. In this case, in a similar way to the parallelization case of the MQ coding as described with respect to FIGS. 27A to 27C, a plurality of code blocks in which parameters are the same as each other are grouped by a predetermined number, and thus, the parallelization can be properly and easily realized.

In the case of parallelizing the bit modeling, if the MQ coding is performed for each parallelized bit modeling, each MQ coding section may be realized as in the MQ coding section 112 in FIG. 8 or may be realized as in the MQ coding section 312 in FIG. 26. The bit modeling parallelization and the MQ coding parallelization may be independently realized.

### 3. Third Embodiment

### Personal Computer

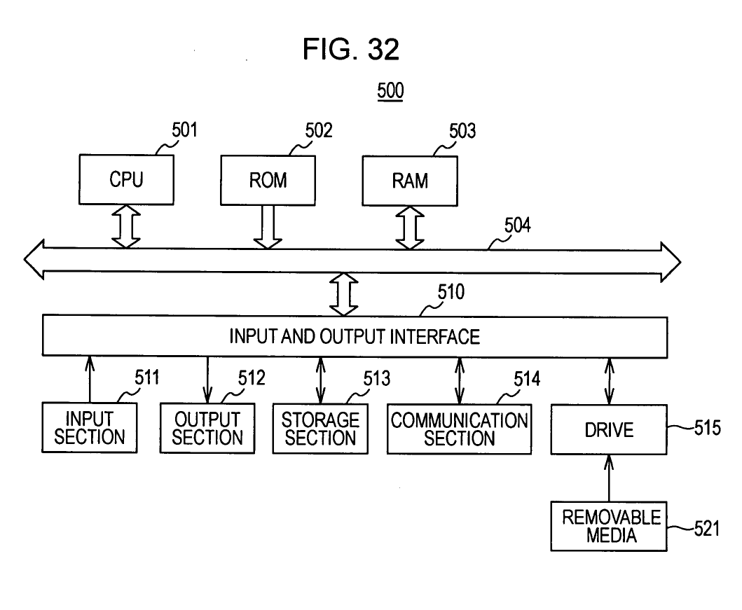

The series of processes as described above can be realized by hardware, or can be realized by software. In this case, a personal computer shown in FIG. 32 may be used by way of example.

In FIG. 32, a CPU (Central Processing Unit) 501 of a personal computer 500 performs a variety of processes according to a program stored in a ROM (Read Only Memory) 502 or a program loaded in a RAM (Random Access Memory) 503 from a storage section 513. In the RAM 503, data or the like which is necessary for the CPU 501 to perform the variety of processes is also appropriately stored.

The CPU 501, the ROM 502 and the RAM 503 are connected to each other through a bus 504. An input and output interface 510 is also connected to the bus 504.

An input section 511 including a keyboard, a mouse or the like; an output section 512 including a display such as a CRT (Cathode Ray Tube) or an LCD (Liquid Crystal Display), a speaker and the like; and a storage section 513 including a hard disc or the like; and a communication section 514 including a modem or the like are connected to the input and output interface 510. The communication section 514 performs a communication process through a network including the Internet.

Further, a drive 515 is connected to the input and output interface 510, and a removable media 521 such as a magnetic disc, optical disc, magneto-optical disc, semiconductor memory or the like are appropriately installed to the input and output interface 510, as necessary. Further, computer programs read from the removable media 521 are installed in the storage section 513 as necessary.

In a case where the above-described series of processes are performed by software, a program for forming the software is installed from a network or a recording medium.

As shown in FIG. 32, this recording medium may be configured by the removable media 521 including a magnetic disc (including a flexible disc), an optical disc (including CD-ROM (Compact Disc-Read Only Memory) and DVD (Digital Versatile Disc)), a magneto-optical disc (including MD (Mini Disc)), a semiconductor memory or the like, in which a program is recorded and which is distributed to a user for delivery of the program being separately provided from a main apparatus body, or may be configured by the ROM 502, a hard disc included in the storage section 513, or the like in which the program is recorded and which is distributed to the user in the state of being assembled in the main apparatus body in advance.

The program executed by the computer may be processed in a time series manner in the order as mentioned in this description, may be processed in parallel, or may be processed at such a necessary timing that the program is called.

Further, in this description, the step of describing the program which is recorded in the recording medium may include a process which is performed in a time series manner in the described order, or may include a process which is performed in parallel or independently, differently from the time series process.

Further, in this description, the term “system” refers to the entire apparatus including a plurality of devices.

In this respect, the configuration described as a single device (or processing section) may be divided into a plurality of devices (or processing sections). Opposite to this, the configuration described as a plurality of devices (or processing sections) may be integrated into a single device (or processing section). Further, a different configuration may be added to the configuration of each device (or processing section). Further, as long as the configuration or operation of the entire system is substantially the same, a part of a configuration of a specific device (or processing section) may be integrated into a configuration of a different device (or different processing section). That is, the embodiments of the present invention are not limited to the above description, and can be variously modified without departing from the spirit of the invention.

The embodiments of the present invention may be applied, for example, to digital cinema editing apparatuses, archive systems, image transmission apparatuses in broadcasting stations, image databases, medical image recording systems, network servers, non-linear editing apparatuses, game machines, television set systems, HDD recorders, authoring tools on personal computers, software modules thereof, or the like.

The present application contains subject matter related to that disclosed in Japanese Priority Patent Application JP 2009-242770 filed in the Japan Patent Office on Oct. 21, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A coding apparatus comprising:
bit modeling means for performing bit modeling for coding for coefficient data of every sub-band obtained by wavelet-transforming image data;
expanding means for expanding a plurality of data sets including a symbol, a context and control information obtained by the bit modeling means in a register as input data;
storing means for storing the input data expanded by the expanding means as buffer data;
integrating means for integrating the data set in which the control information is valid in the input data expanded by the expanding means and the data set in which the control information is valid in the buffer data stored in the storing means; and
coding means for coding the data sets in which the control information is valid, which are integrated by the integrating means.

2. The coding apparatus according to claim 1,
wherein the integrating means integrates the data sets in which the control information is valid by detecting the data set in which the control information is invalid in the buffer data and by moving the data set, which is located in the same position as the detected data set in the buffer data, among the data set in which the control information is valid in the input data to the same position of the buffer data.

3. The coding apparatus according to claim 1, further comprising reading means for reading the buffer data from the storing means in a case where the data set in which the control information is valid is included in the input data, after the data sets are integrated by the integrating means,
wherein the coding section codes the data set in which the control information is valid in the buffer data read by the reading means, and
wherein the storing means stores the input data expanded in the register as new buffer data, after the buffer data is read by the reading means.

4. The coding apparatus according to claim 3, further comprising aligning means for rearranging the buffer data read from the storing means by the reading means to collect the data set in which the control information is valid,
wherein the coding means codes the data set in which the control information is valid, which is rearranged and collected by the aligning means.

5. The coding apparatus according to claim 1,
wherein the coding means codes the different data sets in which the control information is valid, which are integrated by the integrating means, a plurality of times in parallel.

6. The coding apparatus according to claim 1,
wherein the expanding means expands the data set corresponding to each sample, located in the same position, of a plurality of code blocks in the register as the input data.

7. The coding apparatus according to claim 1, further comprising grouping means for grouping the plurality of code blocks by a predetermined number of code blocks having the same characteristic,
wherein the expanding means expands, for every group generated by the grouping means, the data set corresponding to the sample, located in the same position, of each code block in the group, in the register as the input data.

8. The coding apparatus according to claim 7,
wherein the grouping means groups the code blocks on the basis of parameters representing the characteristic of the code blocks, including the horizontal size and vertical size of the code blocks, the number of coding passes used in the code blocks and the sub-band type to which the code blocks belong.

9. The coding apparatus according to claim 1,
wherein the bit modeling means selects one of a CU pass, an SP pass and an MR pass by which the coding is to be performed and performs a predetermined operation by the selected coding pass.

10. The coding apparatus according to claim 9,
wherein the control information is transmitted from the CU pass, and is any one of valid and invalid information in which a result of run-length coding is 0, valid and invalid information in which the run-length coding result is 1, valid and invalid information on whether or not to perform the CU coding, and valid and invalid information on whether or not to perform sign coding.

11. The coding apparatus according to claim 9,
wherein the control information is transmitted from the SP pass, and is any one of valid and invalid information on whether or not to perform SP coding, and valid and invalid information on whether or not to perform sign coding.

12. The coding apparatus according to claim 9,
wherein the control information is transmitted from the MR pass, and is valid and invalid information on whether or not to perform MR coding.

13. A coding method comprising the steps of:
performing bit modeling for coding for coefficient data of every sub-band obtained by wavelet-transforming image data;
expanding a plurality of data sets including a symbol, a context and control information obtained by the bit modeling in a register as input data;
storing the input data expanded in the register in a storing section as buffer data;
integrating the data set in which the control information is valid in the input data expanded in the register and the data set in which the control information is valid in the buffer data stored in the storing section; and
coding the integrated data sets in which the control information is valid.

14. A coding apparatus comprising:
a bit modeling section which performs bit modeling for coding for coefficient data of every sub-band obtained by wavelet-transforming image data;
an expanding section which expands a plurality of data sets including a symbol, a context and control information obtained by the bit modeling section in a register as input data;
a storing section which stores the input data expanded by the expanding section as buffer data;
a integrating section which integrates the data set in which the control information is valid in the input data expanded by the expanding section and the data set in which the control information is valid in the buffer data stored in the storing section; and
a coding section which codes the data sets in which the control information is valid, which are integrated by the integrating section.
